(19) United States
(12) Patent Application Publication
(10) Pub. No.: US 2026/0235140 A1
(43) Pub. Date: Aug. 13, 2026

(54) CENTRIFUGAL COMPRESSOR AND TURBOCHARGER

(71) Applicant: MITSUBISHI HEAVY INDUSTRIES ENGINE & TURBOCHARGER, LTD., Sagamihara-shi, Kanagawa (JP)

(72) Inventors: Daiki KITAGAWA, Tokyo (JP); Yukihide NAGAYO, Tokyo (JP); Kenichiro IWAKIRI, Tokyo (JP); Yuki YAMADA, Tokyo (JP); Yusuke FURUTA, Sagamihara-shi (JP); Akihiro SUGIYAMA, Sagamihara-shi (JP)

(73) Assignee: MITSUBISHI HEAVY INDUSTRIES ENGINE & TURBOCHARGER, LTD., Sagamihara-shi, Kanagawa (JP)

(21) Appl. No.: 19/475,232

(22) PCT Filed: Jun. 2, 2023
(86) PCT No.: PCT/JP2023/020692

§ 371 Date: Oct. 14, 2025

(51) Int. Cl. F04D 29/44; F02B 37/22; F04D 17/10

(52) U.S. Cl. CPC F04D 29/441; F02B 37/225; F04D 17/10

(57) ABSTRACT

This centrifugal compressor is provided with a fluid introduction flow passage for introducing a fluid into a compressor inlet flow passage. An outlet part of the fluid introduction flow passage, wherein a flow passage wall surface of the fluid introduction flow passage includes: a first inclined surface which is positioned on a downstream side in an axial direction of an impeller with respect to an axial line of the fluid introduction flow passage, and is inclined toward the downstream side in the axial direction as approaching the compressor inlet flow passage; and a second inclined surface which is positioned on a downstream side in a rotation direction of the impeller with respect to an axial line of the fluid introduction flow passage, and is inclined toward the downstream side in the rotation direction as approaching the compressor inlet flow passage.

### TECHNICAL FIELD

The present disclosure relates to a centrifugal compressor and a turbocharger.

### BACKGROUND ART

PTL 1 discloses a technique of reducing pressure vibration or an acoustic load on an open cavity by applying a curvature to an entire rear surface of the cavity such that a recess curved surface is formed inside the cavity.

### CITATION LIST

### Patent Literature

[PTL 1] PCT Japanese Translation Patent Publication No. 2019-510174

### SUMMARY OF INVENTION

### Technical Problem

Meanwhile, for example, a centrifugal compressor of a turbocharger may include a compressor inlet flow path that guides air to an impeller and a fluid introduction flow path (for example, a bypass flow path that returns a fluid from a scroll flow path to the compressor inlet flow path or an EGR flow path that returns exhaust gas of an engine to a compressor flow path, or the like) that introduces a fluid into the compressor inlet flow path, and in this case, noise is generated by a vortex generated when a flow in the compressor inlet flow path passes through an outlet (an opening on a side of the compressor inlet flow path in the fluid introduction flow path) of the fluid introduction flow path. In addition, since the direction of the flow in the compressor inlet flow path changes depending on the flow rate of the centrifugal compressor, even if a measure is taken only on the rear surface in one direction in the cavity as in PTL 1, the effect of reducing noise is limited.

In view of the above circumstances, an object of at least one embodiment of the present disclosure is to provide a centrifugal compressor capable of reducing noise generated at an outlet of a fluid introduction flow path even when a flow rate changes, and a turbocharger including the same.

### Solution to Problem

In order to achieve the above object, a centrifugal compressor according to at least one embodiment of the present disclosure includes
an impeller,
a compressor inlet flow path that guides a fluid to the impeller, and
a fluid introduction flow path that is connected to the compressor inlet flow path in a direction intersecting an axis of the compressor inlet flow path and that introduces the fluid into the compressor inlet flow path, in which
at an outlet portion of the fluid introduction flow path, a flow path wall surface of the fluid introduction flow path includes
a first inclined surface that is located on a downstream side in an axial direction of the impeller with respect to an axis of the fluid introduction flow path and that is inclined toward the downstream side in the axial direction as the first inclined surface approaches the compressor inlet flow path, and
a second inclined surface that is located on a downstream side in a rotation direction of the impeller with respect to the axis of the fluid introduction flow path and that is inclined toward the downstream side in the rotation direction as the second inclined surface approaches the compressor inlet flow path.

In order to achieve the above object, a centrifugal compressor according to at least one embodiment of the present disclosure includes
an impeller,
a compressor inlet flow path that guides a fluid to the impeller, and
a fluid introduction flow path that is connected to the compressor inlet flow path in a direction intersecting an axis of the compressor inlet flow path and that introduces the fluid into the compressor inlet flow path, in which
with respect to an end edge on a side of the compressor inlet flow path in the fluid introduction flow path, when a distance between a most upstream position in an axial direction of the impeller in the end edge and the axis of the compressor inlet flow path is denoted as A1, a distance between a most downstream position in the axial direction in the end edge and the axis is denoted as A2, a distance between a most upstream position in a rotation direction of the impeller in the end edge and the axis is denoted as A3, and a distance between a most downstream position in the rotation direction in the end edge and the axis is denoted as A4. A1 and A2 are different from each other, and A3 and A4 are different from each other.

In order to achieve the above object, a centrifugal compressor according to at least one embodiment of the present disclosure includes
an impeller,
a compressor inlet flow path that guides a fluid to the impeller, and
a fluid introduction flow path that is connected to the compressor inlet flow path in a direction intersecting an axis of the compressor inlet flow path and that introduces the fluid into the compressor inlet flow path, in which

Condition (A) below or Condition (B) below is satisfied:
Condition (A): in a cross section along an axial direction of the impeller, an angle formed between a flow path wall surface of the compressor inlet flow path and a flow path wall surface of the fluid introduction flow path on an upstream side of an axis of the fluid introduction flow path in the axial direction is equal to or less than 90 degrees, and in a cross section orthogonal to the axial direction of the impeller, an angle formed between the flow path wall surface of the compressor inlet flow path and the flow path wall surface of the fluid introduction flow path on an upstream side of the axis of the fluid introduction flow path in a rotation direction of the impeller is equal to or less than 90 degrees; and
Condition (B): in a cross section along the axial direction of the impeller, the flow path wall surface of the compressor inlet flow path includes a first convex portion at a position on an upstream side in the axial direction with respect to an outlet of the fluid introduction flow path, and in a cross section orthogonal to the axial direction of the impeller, the flow path wall surface of the compressor inlet flow path includes a second convex portion at a position on an upstream side in the rotation direction of the impeller with respect to the outlet of the fluid introduction flow path.

### Advantageous Effects of Invention

According to at least one embodiment of the present disclosure, there are provided a centrifugal compressor capable of reducing noise generated at an outlet of a fluid introduction flow path even when a flow rate changes, and a turbocharger including the same.

### BRIEF DESCRIPTION OF DRAWINGS

FIG. 1 is a partial cross-sectional view showing a schematic configuration of a turbocharger 2 according to an embodiment.

FIG. 2 is a partially enlarged view showing an example of a shape of a connecting portion between a bypass flow path 16 and a compressor inlet flow path 40 in a centrifugal compressor 4 shown in FIG. 1, and shows a part of a cross section (a cross section including a rotational axis of an impeller 6) along an axial direction in the vicinity of an end portion 24 on the side of the compressor inlet flow path 40 in the bypass flow path 16.

FIG. 3 is a view showing a part of a cross section orthogonal to an axial direction at a position of an axis L1 of the bypass flow path 16 of the centrifugal compressor 4 shown in FIG. 2.

FIG. 4 is a partially enlarged view showing another example of the shape of the connecting portion between the bypass flow path 16 and the compressor inlet flow path 40 in the centrifugal compressor 4 shown in FIG. 1, and shows a part of a cross section (a cross section including the rotational axis of the impeller 6) along the axial direction in the vicinity of the end portion 24 on the side of the compressor inlet flow path 40 in the bypass flow path 16.

FIG. 5 is a view showing a part of a cross section orthogonal to the axial direction at a position of the axis L1 of the bypass flow path 16 of the centrifugal compressor 4 shown in FIG. 4.

FIG. 6 is a view showing a comparison of noise levels of an embodiment shown in FIGS. 4 and 5, a first comparative embodiment, and a second comparative embodiment, in which a case where there is no inclined surface at an outlet portion 16e of the bypass flow path 16 is referred to as a first comparative embodiment and a case where the outlet portion 16e of the bypass flow path 16 includes a first inclined surface 34 but does not include a second inclined surface 36 is referred to as a second comparative embodiment.

FIG. 7 is a partially enlarged view showing another example of the shape of the connecting portion between the bypass flow path 16 and the compressor inlet flow path 40 in the centrifugal compressor 4 shown in FIG. 1, and shows a part of a cross section (a cross section including the rotational axis of the impeller 6) along the axial direction in the vicinity of the end portion 24 on the side of the compressor inlet flow path 40 in the bypass flow path 16.

FIG. 8A is a view showing a part of a cross section orthogonal to the axial direction at a position of the axis L1 of the bypass flow path 16 of the centrifugal compressor 4 shown in FIG. 7.

FIG. 8B is a view for describing details of the configuration shown in FIG. 8A.

FIG. 9 is a partially enlarged view showing another example of the shape of the connecting portion between the bypass flow path 16 and the compressor inlet flow path 40 in the centrifugal compressor 4 shown in FIG. 1, and shows a part of a cross section (a cross section including the rotational axis of the impeller 6) along the axial direction in the vicinity of the end portion 24 on the side of the compressor inlet flow path 40 in the bypass flow path 16.

FIG. 10 is a view showing a part of a cross section orthogonal to the axial direction at a position of the axis L1 of the bypass flow path 16 of the centrifugal compressor 4 shown in FIG. 9.

FIG. 11 is a partially enlarged view showing another example of the shape of the connecting portion between the bypass flow path 16 and the compressor inlet flow path 40 in the centrifugal compressor 4 shown in FIG. 1, and shows a part of a cross section (a cross section including the rotational axis of the impeller 6) along the axial direction in the vicinity of the end portion 24 on the side of the compressor inlet flow path 40 in the bypass flow path 16.

FIG. 12 is a view showing a part of a cross section orthogonal to the axial direction at a position of the bypass flow path 16 of the centrifugal compressor 4 shown in FIG. 11.

FIG. 13 is a partially enlarged view showing another example of the shape of the connecting portion between the bypass flow path 16 and the compressor inlet flow path 40 in the centrifugal compressor 4 shown in FIG. 1, and shows a part of a cross section (a cross section including the rotational axis of the impeller 6) along the axial direction in the vicinity of the end portion 24 on the side of the compressor inlet flow path 40 in the bypass flow path 16.

FIG. 14 is a view showing a part of a cross section orthogonal to the axial direction at a position of the bypass flow path 16 of the centrifugal compressor 4 shown in FIG. 13.

FIG. 15 is a partially enlarged view showing another example of the shape of the connecting portion between the bypass flow path 16 and the compressor inlet flow path 40 in the centrifugal compressor 4 shown in FIG. 1, and shows a part of a cross section (a cross section including the rotational axis of the impeller 6) along the axial direction in the vicinity of the end portion 24 on the side of the compressor inlet flow path 40 in the bypass flow path 16.

FIG. 16 is a view showing a part of a cross section orthogonal to the axial direction at a position of the axis L1 of the bypass flow path 16 of the centrifugal compressor 4 shown in FIG. 15.

FIG. 17 is a partially enlarged view showing another example of the shape of the connecting portion between the bypass flow path 16 and the compressor inlet flow path 40 in the centrifugal compressor 4 shown in FIG. 1, and shows a part of a cross section (a cross section including the rotational axis of the impeller 6) along the axial direction in the vicinity of the end portion 24 on the side of the compressor inlet flow path 40 in the bypass flow path 16.

FIG. 18 is a view showing a part of a cross section orthogonal to the axial direction at a position of the axis L1 of the bypass flow path 16 of the centrifugal compressor 4 shown in FIG. 17.

### DESCRIPTION OF EMBODIMENTS

Hereinafter, some embodiments of the present disclosure will be described with reference to the accompanying drawings. However, dimensions, materials, shapes, relative dispositions, and the like of components described as embodiments or shown in the drawings are not intended to limit the scope of the invention, but are only explanatory examples.

For example, an expression representing a relative or absolute arrangement such as “in a certain direction”, “along a certain direction”, “parallel”, “orthogonal”, “center”, “concentric”, or “coaxial” does not strictly represent only such an arrangement, but also a tolerance or a state of being relatively displaced with an angle or a distance to the extent that the same function can be obtained.

For example, expressions such as “identical”. “equal”, and “homogeneous” indicating that things are in an equal state do not strictly represent only the equal state, but also a tolerance or a state where there is a difference to the extent that the same function can be obtained.

For example, an expression representing a shape such as a quadrangular shape or a cylindrical shape does not represent only a shape such as a quadrangular shape or a cylindrical shape in a geometrically strict sense, but also a shape including an uneven portion, a chamfered portion, and the like within a range in which the same effect can be obtained.

Meanwhile, the expressions “being provided with”, “comprising”, “including”, or “having” one component are not exclusive expressions excluding the presence of other components.

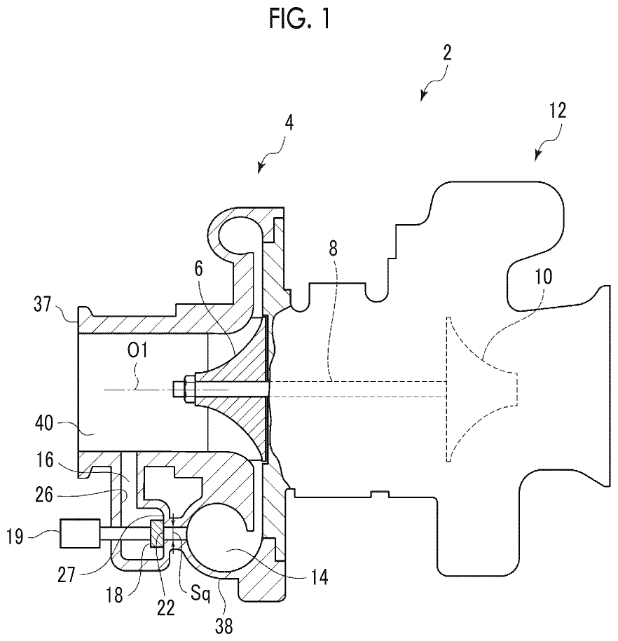

FIG. 1 is a partial cross-sectional view showing a schematic configuration of a turbocharger 2 according to an embodiment.

As shown in FIG. 1, the turbocharger 2 includes a centrifugal compressor 4 and a turbine 12 including a turbine rotor 10 that shares an impeller 6 and a rotary shaft 8 of the centrifugal compressor 4.

The centrifugal compressor 4 includes an impeller 6, a compressor inlet flow path 40 that guides air to the impeller 6, a scroll flow path 14 provided on an outer peripheral side of the impeller 6, a bypass flow path 16 that connects the compressor inlet flow path 40 and an outlet pipe 38 of the scroll flow path 14 by bypassing the impeller 6, and a bypass valve 18 capable of opening and closing a valve port 22 provided in the bypass flow path 16. The bypass valve 18 is provided in an intermediate portion of the bypass flow path 16, and a valve seat surface 27 with which the bypass valve 18 abuts is formed on a flow path wall surface 26 of the bypass flow path 16. The bypass valve 18 is controlled to be opened and closed by an actuator 19, is opened when the discharge pressure of the centrifugal compressor 4 excessively increases, and causes a part of the compressed air flowing in the scroll flow path 14 to be recirculated to the compressor inlet flow path 40. That is, the bypass flow path 16 is a fluid introduction flow path for introducing a fluid (here, a portion of the compressed air compressed by the impeller 6) into the compressor inlet flow path 40. In the illustrated exemplary embodiment, the compressor inlet flow path 40 is configured with a compressor inlet pipe 37 extending in a straight-line shape along a rotational axis O1 of the impeller 6. The bypass flow path 16 is connected to the compressor inlet flow path 40 in a direction intersecting the axis O1 of the compressor inlet flow path 40 (axis coinciding with the rotational axis O1 of the impeller 6).

Hereinafter, an “axial direction” means an axial direction of the impeller 6 unless otherwise specified, a “circumferential direction” means a circumferential direction of the impeller 6 unless otherwise specified, and a “radial direction” means a radial direction of the impeller 6 unless otherwise specified. The axial direction of the impeller 6 coincides with the axial direction of the compressor inlet flow path 40 (axial direction of the compressor inlet pipe 37), the circumferential direction of the impeller 6 coincides with the circumferential direction of the compressor inlet flow path 40 (circumferential direction of the compressor inlet pipe 37), and the radial direction of the impeller 6 coincides with the radial direction of the compressor inlet flow path 40 (radial direction of the compressor inlet pipe 37).

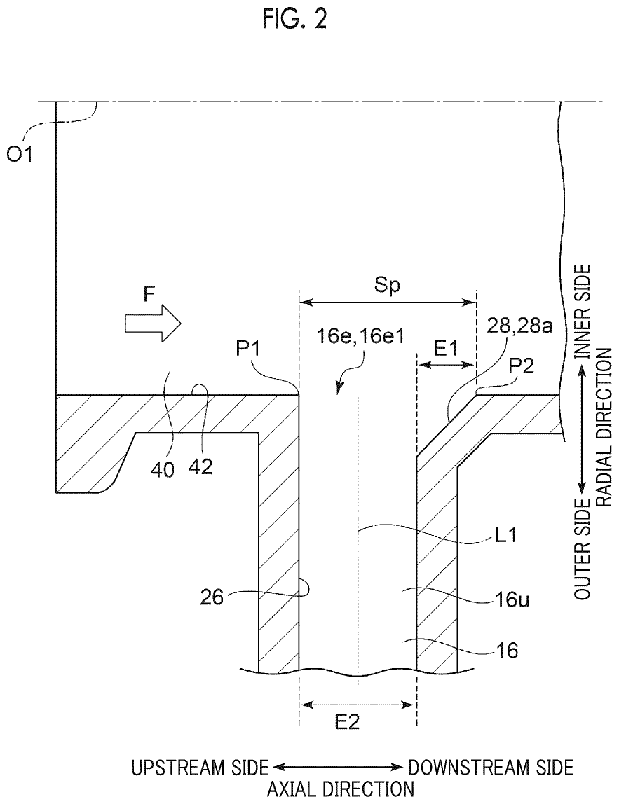

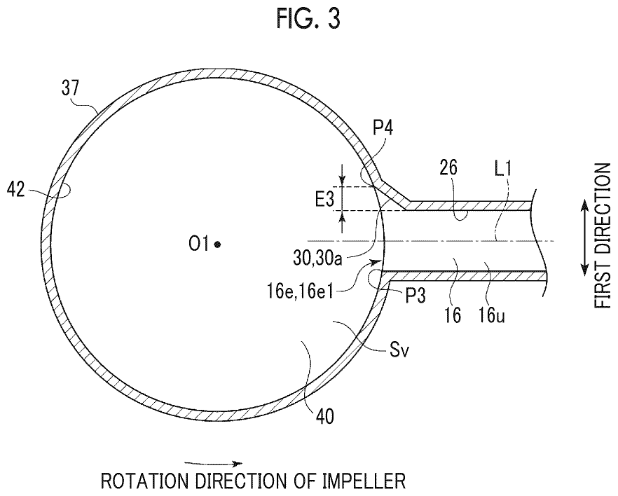

FIG. 2 is a partially enlarged view showing an example of a shape of a connecting portion between the bypass flow path 16 and the compressor inlet flow path 40 in the centrifugal compressor 4 shown in FIG. 1, and shows a part of a cross section (cross section including the axis O1 of the compressor inlet flow path 40) along the axial direction in the vicinity of the outlet portion 16e of the bypass flow path 16. FIG. 3 is a view showing a part of a cross section orthogonal to the axial direction at a position of the axis L1 of the bypass flow path 16 with respect to the centrifugal compressor 4 shown in FIG. 2.

In some embodiments, as shown in FIGS. 2 and 3, in the outlet portion 16e of the bypass flow path 16, the flow path wall surface 26 of the bypass flow path 16 includes a first inclined surface 28 and a second inclined surface 30. The outlet portion 16e of the bypass flow path 16 means an end portion on the side of the compressor inlet flow path 40 in the bypass flow path 16.

As shown in FIG. 2, the first inclined surface 28 is located on a downstream side in the axial direction with respect to the axis L1 of the bypass flow path 16, and is inclined toward the downstream side in the axial direction as the first inclined surface 28 approaches the compressor inlet flow path 40 (as it moves toward an inner side in the radial direction). In the illustrated exemplary embodiment, in a cross section along the axial direction, the first inclined surface 28 includes a straight line 28a that extends toward the downstream side in the axial direction as the straight line 28a approaches the compressor inlet flow path 40, and the straight line 28a is inclined with respect to the axis L1 of the bypass flow path 16. The axis L1 of the bypass flow path 16 means the axis of the pipe configuring the bypass flow path 16.

As shown in FIG. 3, the second inclined surface 30 is located on the downstream side in the rotation direction of the impeller 6 with respect to the axis L1 of the bypass flow path 16, and is inclined toward the downstream side in the rotation direction of the impeller 6 as the second inclined surface 30 approaches the compressor inlet flow path 40 (as it moves toward the inner side in the radial direction). In the illustrated exemplary embodiment, in a cross section orthogonal to the axial direction, the second inclined surface 30 includes a straight line 30a that extends toward the downstream side in the rotation direction of the impeller 6 as the straight line 30a approaches the compressor inlet flow path 40, and the straight line 30a is inclined with respect to the axis L1 of the bypass flow path 16.

Under the operating condition on a high flow rate side in the centrifugal compressor 4, the air flowing through the compressor inlet flow path 40 flows along the axial direction as indicated by an arrow F in FIG. 2, and the swirling component of the impeller 6 in the rotation direction in the flow in the compressor inlet flow path 40 is relatively small. On the other hand, under the operating condition on a low flow rate side in the centrifugal compressor 4, the influence of the rotation of the impeller 6 on the flow in the compressor inlet flow path 40 becomes stronger, and the swirling component in the rotation direction of the impeller 6 in the flow in the compressor inlet flow path 40 becomes relatively large.

In this regard, in the centrifugal compressor 4 shown in FIGS. 2 and 3, the flow path wall surface 26 includes the first inclined surface 28 on the downstream side in the axial direction with respect to the axis L1 of the bypass flow path 16 in the outlet portion 16e of the bypass flow path 16. Therefore,
under the operating condition on the high flow rate side in the centrifugal compressor 4, when the air (main flow) flowing through the compressor inlet flow path 40 along the axial direction passes through an outlet 16e1 of the bypass flow path 16, even if a vortex is generated at a position P1 (position of a leading edge of the outlet with respect to the flow in the axial direction) of an end edge on an upstream side in the axial direction at the outlet 16e1, compared to a case where the flow path wall surface 26 of the bypass flow path 16 is not inclined with respect to the axis L1 of the bypass flow path 16, it is possible to alleviate the pressure fluctuation caused by the collision of the vortex with the vicinity of a position P2 (position of a trailing edge of the outlet with respect to the flow in the axial direction) of an end edge on the downstream side in the axial direction at the outlet 16e1 of the bypass flow path 16, and it is possible to reduce noise generated at the outlet 16e1 of the bypass flow path 16. The outlet 16e1 of the bypass flow path 16 is an opening on the side of the compressor inlet flow path 40 in the bypass flow path 16. The cross-sectional shape of the outlet 16e1 may be, for example, a rectangular shape, or may be an oval shape such as a circular shape or an elliptical shape.

In addition, in the outlet portion 16e of the bypass flow path 16, the flow path wall surface 26 of the bypass flow path 16 includes the second inclined surface 30 on the downstream side in the rotation direction of the impeller 6 with respect to the axis L1 of the bypass flow path 16. Therefore, under the operating condition on the low flow rate side in the centrifugal compressor 4, when the swirling flow of the air flowing through the compressor inlet flow path 40 passes through the outlet 16e1 of the bypass flow path 16, even if a vortex is generated at a position P3 (position of a leading edge of the outlet 16e1 with respect to the swirling flow in the rotation direction of the impeller 6) of an end edge on an upstream side in the rotation direction of the impeller 6 at the outlet 16e1, compared to a case where the flow path wall surface 26 of the bypass flow path 16 is not inclined with respect to the axis L1 of the bypass flow path 16, it is possible to alleviate the pressure fluctuation caused by the collision of the vortex with the vicinity of a position P4 (position of a trailing edge of the outlet 16e1 with respect to the swirling flow in the rotation direction of the impeller 6) of an end edge on the downstream side in the rotation direction of the impeller 6 at the outlet 16e1, and it is possible to reduce noise generated at the outlet 16e1 of the bypass flow path 16.

Therefore, according to the centrifugal compressor 4, even when the flow rate changes, noise generated at the outlet 16e1 of the bypass flow path 16 can be effectively reduced.

In some embodiments, for example, as shown in FIGS. 1 and 2, when an area of the outlet 16e1 of the bypass flow path 16 is denoted as Sp and a flow path area of the bypass flow path 16 (that is, a flow path area of the valve port 22) at a position of the valve seat surface 27 is denoted as Sq, Sp>Sq may be satisfied. The area of the outlet 16e1 of the bypass flow path 16 means the area of an opening formed at a position at which the flow path wall surface 26 of the bypass flow path 16 is connected to a flow path wall surface 42 of the compressor inlet flow path 40, and means the area of the opening defined by the position of an inner end of the first inclined surface 28 in the radial direction.

According to such a configuration, noise generated at the outlet 16e1 of the bypass flow path 16 can be reduced while the influence on the performance of the centrifugal compressor 4 is suppressed due to the provision of the first inclined surface 28 and the second inclined surface 30.

In some embodiments, for example, as shown in FIG. 2, when a dimension of the first inclined surface 28 in the axial direction is denoted as E1 and a flow path width of a flow path portion 16u in the axial direction adjacent to the upstream side of the first inclined surface 28 in the bypass flow path 16 is denoted as E2, E1≥0.1×E2 may be satisfied. In this manner, noise generated at the outlet 16e1 of the bypass flow path 16 can be effectively reduced.

In some embodiments, for example, as shown in FIG. 3, when a direction orthogonal to each of the axial direction and the axis L1 of the bypass flow path 16 is defined as a first direction, a dimension of the second inclined surface 30 in the first direction is denoted as E3, and a flow path width of the flow path portion 16u in the first direction adjacent to the upstream side of the second inclined surface 30 in the bypass flow path 16 is denoted as E4, E3≥0.1×E4 may be satisfied. In this manner, noise generated at the outlet 16e1 of the bypass flow path 16 can be effectively reduced.

In some embodiments, for example, as shown in FIGS. 2 and 3, when an area of the outlet 16e1 of the bypass flow path 16 is denoted as Sp and a flow path area of the compressor inlet flow path 40 at a position of the outlet 16e1 is denoted as Sv, Sp<0.35×Sv may be satisfied. When Sp/Sv exceeds 0.35 (that is, when an extent of an angle range in which the outlet 16e1 of the bypass flow path 16 in the circumferential direction is present exceeds 60 degrees), the influence on the performance of the centrifugal compressor 4 increases sharply, so that, by satisfying Sp<0.35×Sv as described above, noise generated at the outlet 16e1 of the bypass flow path 16 can be reduced while the influence on the performance of the centrifugal compressor 4 is suppressed.

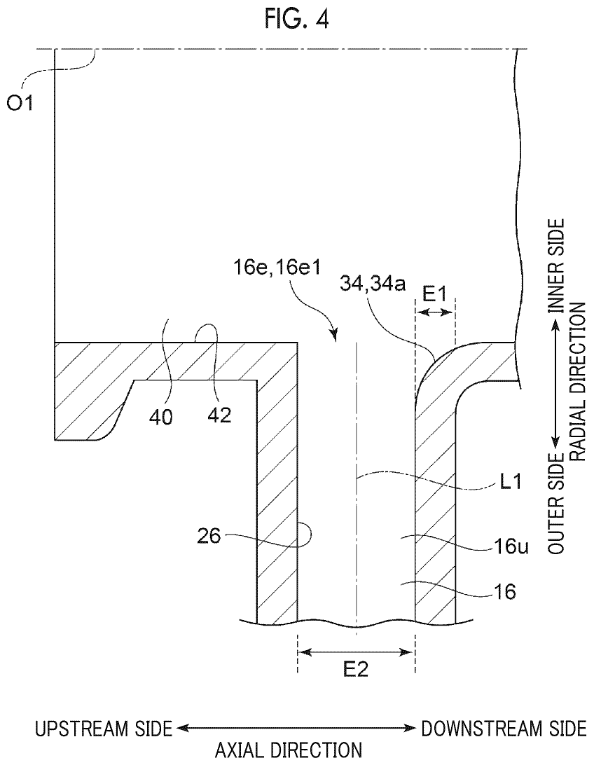

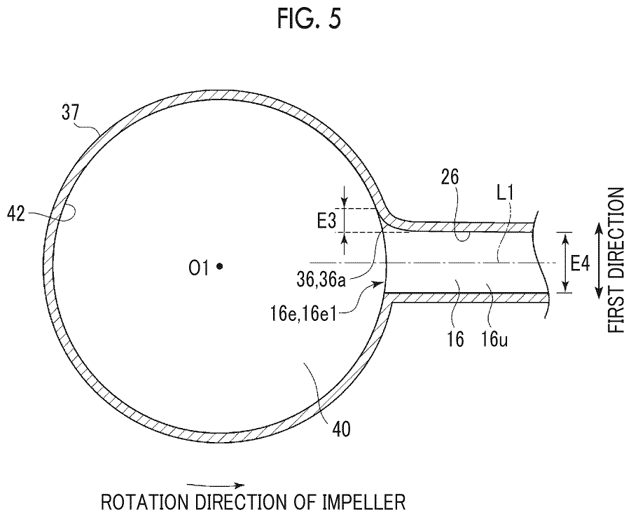

FIG. 4 is a partially enlarged view showing another example of the shape of the connecting portion between the bypass flow path 16 and the compressor inlet flow path 40 in the centrifugal compressor 4 shown in FIG. 1, and shows a part of a cross section (cross section including the axis O1 of the compressor inlet flow path 40) along the axial direction in the vicinity of the outlet portion 16e of the bypass flow path 16. FIG. 5 is a view showing a part of a cross section orthogonal to the axial direction at a position of the axis L1 of the bypass flow path 16 with respect to the centrifugal compressor 4 shown in FIG. 4.

In some embodiments, as shown in FIGS. 4 and 5, in the outlet portion 16e of the bypass flow path 16, the flow path wall surface 26 of the bypass flow path 16 includes the first inclined surface 34 and the second inclined surface 36.

As shown in FIG. 4, the first inclined surface 34 is located on the downstream side in the axial direction with respect to the axis L1 of the bypass flow path 16, and is inclined toward the downstream side in the axial direction as the first inclined surface 34 approaches the compressor inlet flow path 40 (as it moves toward the inner side in the radial direction). In the illustrated exemplary embodiment, in a cross section along the axial direction, the first inclined surface 34 includes a curved convex curve 34a that extends toward the downstream side in the axial direction as the curved convex curve 34a approaches the compressor inlet flow path 40.

As shown in FIG. 5, the second inclined surface 36 is located on the downstream side in the rotation direction of the impeller 6 with respect to the axis L1 of the bypass flow path 16, and is inclined toward the downstream side in the rotation direction of the impeller 6 as the second inclined surface 36 approaches the compressor inlet flow path 40 (as it moves toward the inner side in the radial direction). In the illustrated exemplary embodiment, in a cross section orthogonal to the axial direction, the second inclined surface 36 includes a curved convex curve 36a that extends toward the downstream side in the rotation direction of the impeller 6 as the curved convex curve 36a approaches the compressor inlet flow path 40.

Also in the centrifugal compressor 4 shown in FIGS. 4 and 5, for the same reason as in the centrifugal compressor 4 shown in FIGS. 2 and 3, noise generated at the outlet 16e1 of the bypass flow path 16 can be effectively reduced even when the flow rate is changed.

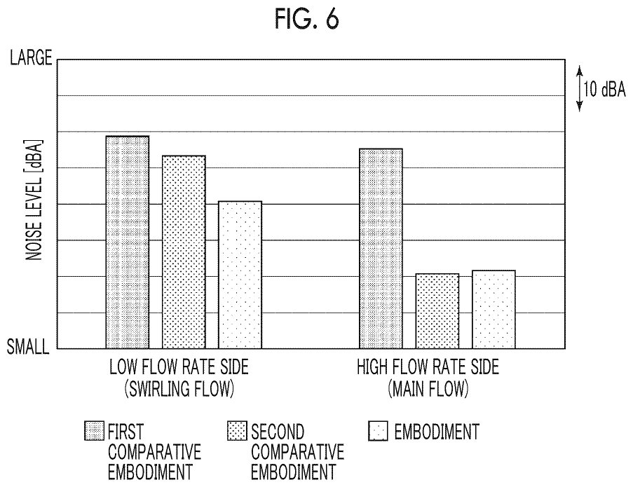

FIG. 6 is a test result showing a comparison of noise levels of the embodiment shown in FIGS. 4 and 5, a first comparative embodiment, and a second comparative embodiment, in which a case where there is no inclined surface in the outlet portion 16e of the bypass flow path 16 (a case where the flow path wall surface 26 of the bypass flow path 16 is not inclined with respect to the axis L1 of the bypass flow path 16 in the outlet portion 16e of the bypass flow path 16) is referred to as the first comparative embodiment and a case where the outlet portion 16e of the bypass flow path 16 includes the first inclined surface 34 but does not include the second inclined surface 36 is referred to as the second comparative embodiment.

As shown in FIG. 6, on the high flow rate side of the centrifugal compressor, the flow (main flow) in the axial direction is dominant in the compressor inlet flow path 40, so that noise can be reduced as long as the first inclined surface 34 is provided regardless of the presence or absence of the second inclined surface 36. In contrast, on the low flow rate side of the centrifugal compressor, a swirling flow with a strong swirling component is formed in the compressor inlet flow path 40, so that the reduction effect of the noise level by the second comparative embodiment including only the first inclined surface 34 is limited, and, on the other hand, in the embodiment including both the first inclined surface 34 and the second inclined surface 36, the noise level can be significantly reduced.

In some embodiments, for example, as shown in FIG. 4, when a dimension of the first inclined surface 34 in the axial direction is denoted as E1 and a flow path width of the flow path portion 16u in the axial direction adjacent to the upstream side of the first inclined surface 34 in the bypass flow path 16 is denoted as E2, E1≥0.1×E2 may be satisfied. In this manner, noise generated at the outlet 16e1 of the bypass flow path 16 can be effectively reduced.

In some embodiments, for example, as shown in FIG. 5, when a direction orthogonal to each of the axial direction and the axis L1 of the bypass flow path 16 is defined as the first direction, a dimension of the second inclined surface 36 in the first direction is denoted as E3, and a flow path width of the flow path portion 16u in the first direction adjacent to the upstream side of the second inclined surface 36 in the bypass flow path 16 is denoted as E4, E3≥0.1×E4 may be satisfied. In this manner, noise generated at the outlet 16e1 of the bypass flow path 16 can be effectively reduced.

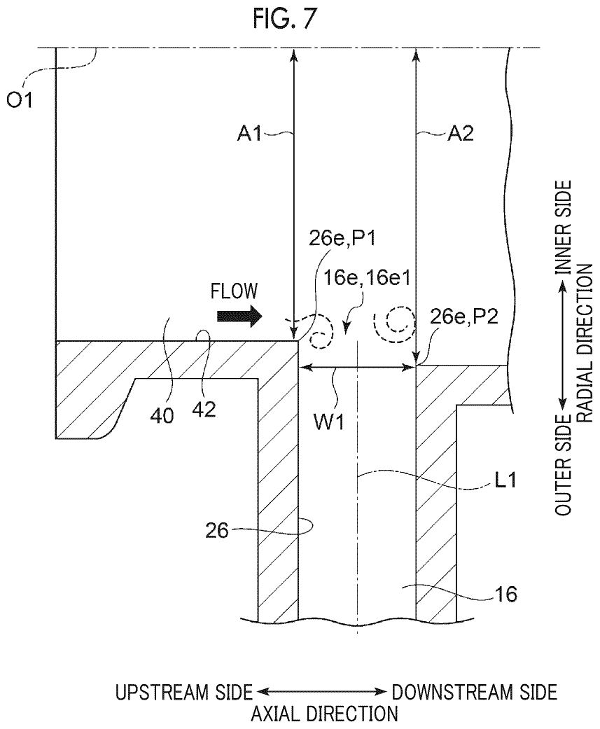

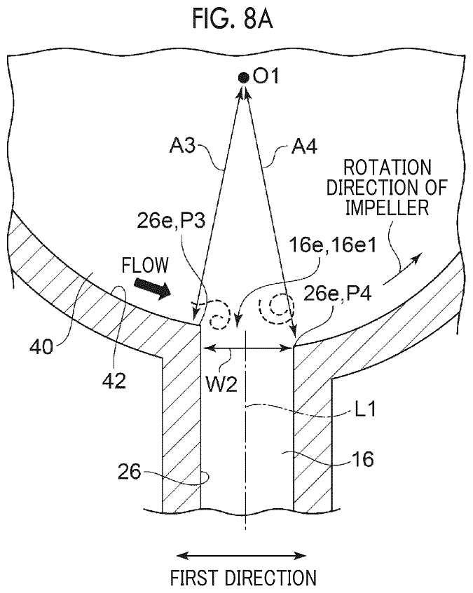

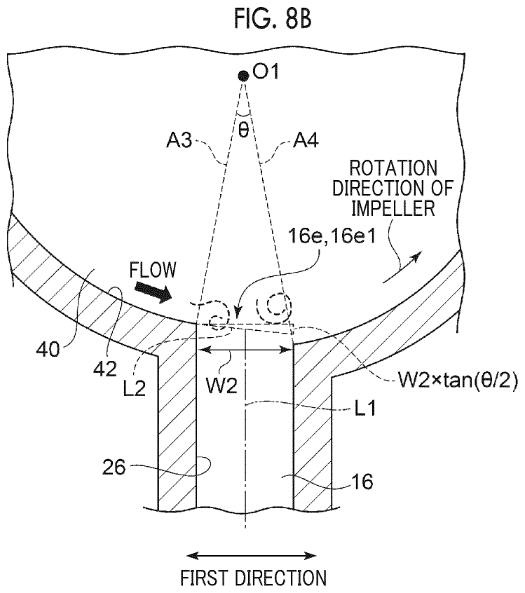

FIG. 7 is a partially enlarged view showing another example of the shape of the connecting portion between the bypass flow path 16 and the compressor inlet flow path 40 in the centrifugal compressor 4 shown in FIG. 1, and shows a part of a cross section (cross section including the axis O1 of the compressor inlet flow path 40) along the axial direction in the vicinity of the outlet portion 16e of the bypass flow path 16. FIG. 8A is a view showing a part of a cross section orthogonal to the axial direction at a position of the axis L1 of the bypass flow path 16 with respect to the centrifugal compressor 4 shown in FIG. 7. FIG. 8B is a view for describing details of the configuration shown in FIG. 8A.

In some embodiments, as shown in FIGS. 7 and 8A, with respect to an end edge 26e of the bypass flow path 16 on the side of the outlet 16e1 in the flow path wall surface 26 of the bypass flow path 16, when a distance between the most upstream position P1 in the axial direction in the end edge 26e and the axis O1 of the compressor inlet flow path 40 is denoted as A1, a distance between the most downstream position P2 in the axial direction in the end edge 26e and the axis O1 is denoted as A2, a distance between the most upstream position P3 in the rotation direction of the impeller 6 in the end edge 26e and the axis O1 of the compressor inlet flow path 40 is denoted as A3, and a distance between the most downstream position P4 in the rotation direction of the impeller 6 in the end edge 26e and the axis O1 is denoted as A4, the distance A1 and the distance A2 are different from each other, and the distance A3 and the distance A4 are different from each other. In addition, in the embodiment shown in FIGS. 7 and 8A, A1<A2 and A3<A4 are satisfied. That is, A1 is smaller than A2, A3 is smaller than A4, there is a step in the radial direction between the most upstream position P1 and the most downstream position P2, and there is a step in the radial direction between the most upstream position P3 and the most downstream position P4.

In the embodiments shown in FIGS. 7 and 8A, the distance A1 and the distance A2 are different from each other, so that, with respect to the end edge 26e on the side of the compressor inlet flow path 40 in the flow path wall surface 26 of the bypass flow path 16, a step is formed in the radial direction between the most upstream position P1 in the axial direction in the end edge 26e and the most downstream position P2 in the axial direction in the end edge 26e. Therefore, under the operating condition on the high flow rate side in the centrifugal compressor 4, when the air (main flow) flowing through the compressor inlet flow path 40 along the axial direction passes through the outlet 16e1 of the bypass flow path 16, even if a vortex is generated at the position P1 (position of the leading edge of the outlet with respect to the flow in the axial direction) of the end edge on the upstream side in the axial direction at the outlet 16e1, it is possible to suppress or avoid collision of the vortex with the position P2 (position of the trailing edge of the outlet with respect to the flow in the axial direction) of the end edge on the downstream side in the axial direction at the outlet 16e1 of the bypass flow path 16, and it is possible to suppress pressure fluctuations caused by the collision to reduce noise at the outlet 16e1 of the bypass flow path 16.

In addition, in the embodiment shown in FIGS. 7 and 8A, the distance A3 and the distance A4 are different from each other, so that, with respect to the end edge 26e on the side of the compressor inlet flow path 40 in the flow path wall surface 26 of the bypass flow path 16, a step in the radial direction is formed between the most upstream position P3 in the rotation direction of the impeller 6 in the end edge 26e and the most downstream position P4 in the rotation direction of the impeller 6 in the end edge 26e. Therefore, under the operating condition on the low flow rate side in the centrifugal compressor 4, when the swirling flow of the air flowing through the compressor inlet flow path 40 passes through the outlet 16e1 of the bypass flow path 16, even if a vortex is generated at the position P3 (position of the leading edge of the outlet 16e1 with respect to the swirling flow in the rotation direction of the impeller 6) of the end edge on the upstream side in the rotation direction of the impeller 6 at the outlet 16e1, it is possible to suppress or avoid collision of the vortex with the position P4 (position of the trailing edge of the outlet 16e1 with respect to the swirling flow in the rotation direction of the impeller 6) of the end edge on the downstream side in the rotation direction at the outlet 16e1 of the bypass flow path 16, and it is possible to suppress pressure fluctuations caused by the collision to reduce noise at the outlet 16e1 of the bypass flow path 16.

Therefore, even in the embodiment shown in FIGS. 7 and 8A, noise generated at the outlet 16e1 of the bypass flow path 16 can be effectively reduced even when the flow rate changes. In addition, since it is not necessary to increase the area of the outlet 16e1 of the bypass flow path 16, noise can be reduced while the influence on the performance of the centrifugal compressor 4 is suppressed.

In some embodiments, as shown in FIGS. 7 and 8A, when a flow path width of the bypass flow path 16 in the axial direction at a position of the outlet 16e1 of the bypass flow path 16 is denoted as W1 and a flow path width of the bypass flow path 16 in the first direction (direction orthogonal to each of the axial direction and the axis L1 of the bypass flow path 16) at a position of the outlet 16e1 of the bypass flow path 16 is denoted as W2, at least one of Expression (a1) below and Expression (a2) below may be satisfied:

$$\vert A 1 - A 2 \vert \geq 0.35 \times W 1 \qquad ( a 1 )$$

$$\vert A 3 - A 4 \vert \geq 0.35 \times W 2. \qquad ( a 2 )$$

That is, among the above Expression (a1) and the above Expression (a2), only the above Expression (a1) may be satisfied, only the above Expression (a2) may be satisfied, or both the above Expressions (a1) and (a2) may be satisfied.

The larger each of the flow path widths W1 and W2 is, the deeper the flow in the compressor inlet flow path 40 along the circumferential direction penetrates into the bypass flow path 16, and wider the range of collision with the flow path wall surface 42 of the bypass flow path 16 is. In this regard, by satisfying at least one of the above Expressions (a1) and (a2), it is possible to effectively suppress the collision of the vortex with the flow path wall surface 26 of the bypass flow path 16 and to suppress noise caused by the collision of the vortex.

In some embodiments, as shown in FIG. 8B, when the flow path width of the bypass flow path 16 in the first direction (direction orthogonal to each of the axial direction and the axis L1 of the bypass flow path 16) at the position of the outlet 16e1 of the bypass flow path 16 is denoted as W2, and the extent of the angle range in which the outlet 16e1 of the bypass flow path 16 is present in the circumferential direction is denoted as θ, Expression (b) below may be satisfied:

$$\vert A 3 - A 4 \vert > W 2 \times tan ( θ / 2 ) . \qquad Expression ( b )$$

As shown in FIG. 8B, when an imaginary line extending in a tangential direction of a circle configuring the flow path wall surface 42 of the compressor inlet flow path 40 from the position P3 of the end edge on the upstream side in the rotation direction of the impeller 6 at the outlet 16e1 in a cross section orthogonal to the axial direction is denoted as L2, in a case where the above Expression (b) is satisfied, the position P4 of the end edge on the downstream side in the rotation direction of the impeller 6 at the outlet 16e1 in the cross section orthogonal to the axial direction is on an outer side in the radial direction with respect to the imaginary line L2. Therefore, when the swirling flow of air flowing through the compressor inlet flow path 40 passes through the outlet 16e1 of the bypass flow path 16, even if a vortex is generated at the position P3 (position of the leading edge of the outlet 16e1 with respect to the swirling flow in the rotation direction of the impeller 6) of the end edge on the upstream side in the rotation direction of the impeller 6 at the outlet 16e1, it is possible to suppress or avoid collision of the vortex with the position P4 (position of the trailing edge of the outlet 16e1 with respect to the swirling flow in the rotation direction of the impeller 6) of the end edge on the downstream side in the rotation direction at the outlet 16e1 of the bypass flow path 16, and it is possible to effectively suppress noise caused by the collision of the vortex.

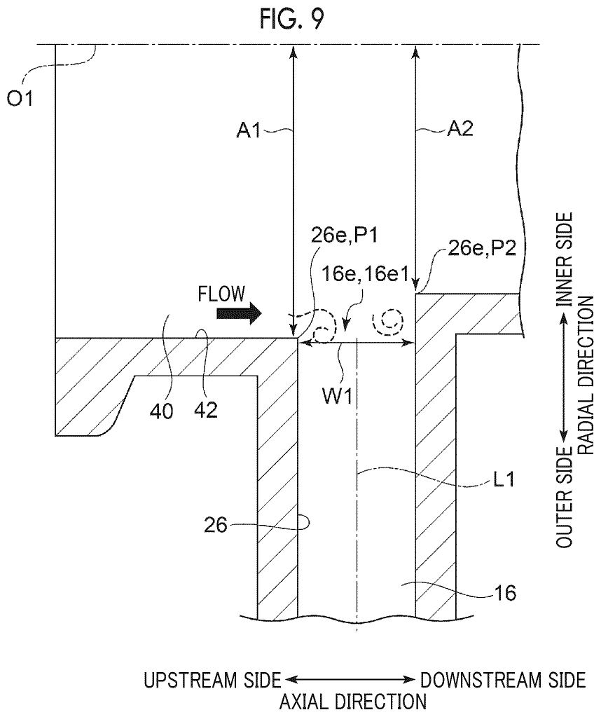

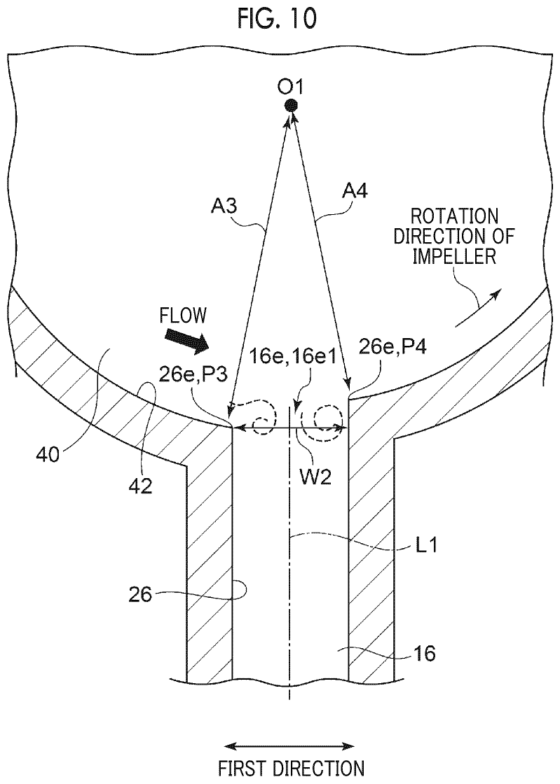

FIG. 9 is a partially enlarged view showing another example of the shape of the connecting portion between the bypass flow path 16 and the compressor inlet flow path 40 in the centrifugal compressor 4 shown in FIG. 1, and shows a part of a cross section (cross section including the axis O1 of the compressor inlet flow path 40) along the axial direction in the vicinity of the outlet portion 16e of the bypass flow path 16. FIG. 10 is a view showing a part of a cross section orthogonal to the axial direction at a position of the axis L1 of the bypass flow path 16 with respect to the centrifugal compressor 4 shown in FIG. 9.

In some embodiments, as shown in FIGS. 9 and 10, with respect to the end edge 26e of the bypass flow path 16 on the side of the outlet 16e1 in the flow path wall surface 26 of the bypass flow path 16, when a distance between the most upstream position P1 in the axial direction in the end edge 26e and the axis O1 of the compressor inlet flow path 40 is denoted as A1, a distance between the most downstream position P2 in the axial direction in the end edge 26e and the axis O1 is denoted as A2, a distance between the most upstream position P3 in the rotation direction of the impeller 6 in the end edge 26e and the axis O1 of the compressor inlet flow path 40 is denoted as A3, and a distance between the most downstream position P4 in the rotation direction of the impeller 6 in the end edge 26e and the axis O1 is denoted as A4, A1 and A2 are different from each other, and A3 and A4 are different from each other. In addition, in the embodiments shown in FIGS. 9 and 10, A1>A2 and A3>A4 are satisfied. That is, A1 is larger than A2, A3 is larger than A4, there is a step in the radial direction between the most upstream position P1 and the most downstream position P2, and there is a step in the radial direction between the most upstream position P3 and the most downstream position P4.

In the embodiments shown in FIGS. 9 and 10, the distance A1 and the distance A2 are different from each other, so that, with respect to the end edge 26e on the side of the compressor inlet flow path 40 in the flow path wall surface 26 of the bypass flow path 16, a step is formed in the radial direction between the most upstream position P1 in the axial direction in the end edge 26e and the most downstream position P2 in the axial direction in the end edge 26e. Therefore, under the operating condition on the high flow rate side in the centrifugal compressor 4, when the air (main flow) flowing through the compressor inlet flow path 40 along the axial direction passes through the outlet 16e1 of the bypass flow path 16, even if a vortex is generated at the position P1 (position of the leading edge of the outlet with respect to the flow in the axial direction) of the end edge on the upstream side in the axial direction at the outlet 16e1, it is possible to suppress or avoid collision of the vortex with the position P2 (position of the trailing edge of the outlet with respect to the flow in the axial direction) of the end edge on the downstream side in the axial direction at the outlet 16e1 of the bypass flow path 16, and it is possible to suppress pressure fluctuations caused by the collision to reduce noise at the outlet 16e1 of the bypass flow path 16.

In addition, in the embodiment shown in FIGS. 9 and 10, the distance A3 and the distance A4 are different from each other, so that, with respect to the end edge 26e on the side of the compressor inlet flow path 40 in the flow path wall surface 26 of the bypass flow path 16, a step in the radial direction is formed between the most upstream position P3 in the rotation direction of the impeller 6 in the end edge 26e and the most downstream position P4 in the rotation direction of the impeller 6 in the end edge 26e. Therefore, under the operating condition on the low flow rate side in the centrifugal compressor 4, when the swirling flow of the air flowing through the compressor inlet flow path 40 passes through the outlet 16e1 of the bypass flow path 16, even if a vortex is generated at the position P3 (position of the leading edge of the outlet 16e1 with respect to the swirling flow in the rotation direction of the impeller 6) of the end edge on the upstream side in the rotation direction of the impeller 6 at the outlet 16e1, it is possible to suppress or avoid collision of the vortex with the position P4 (position of the trailing edge of the outlet 16e1 with respect to the swirling flow in the rotation direction of the impeller 6) of the end edge on the downstream side in the rotation direction at the outlet 16e1 of the bypass flow path 16, and it is possible to suppress pressure fluctuations caused by the collision to reduce noise at the outlet 16e1 of the bypass flow path 16.

Therefore, even in the embodiment shown in FIGS. 9 and 10, noise generated at the outlet 16e1 of the bypass flow path 16 can be effectively reduced even when the flow rate changes. In addition, since it is not necessary to increase the area of the outlet 16e1 of the bypass flow path 16, noise can be reduced while the influence on the performance of the centrifugal compressor 4 is suppressed.

In some embodiments, as shown in FIGS. 9 and 10, when a flow path width of the bypass flow path 16 in the axial direction at a position of the outlet 16e1 of the bypass flow path 16 is denoted as W1 and a flow path width of the bypass flow path 16 in the first direction at a position of the outlet 16e1 of the bypass flow path 16 is denoted as W2, at least one of the above Expression (a1) and the above Expression (a2) may be satisfied. That is, among the above Expression (a1) and the above Expression (a2), only the above Expression (a1) may be satisfied, only the above Expression (a2) may be satisfied, or both the above Expressions (a1) and (a2) may be satisfied.

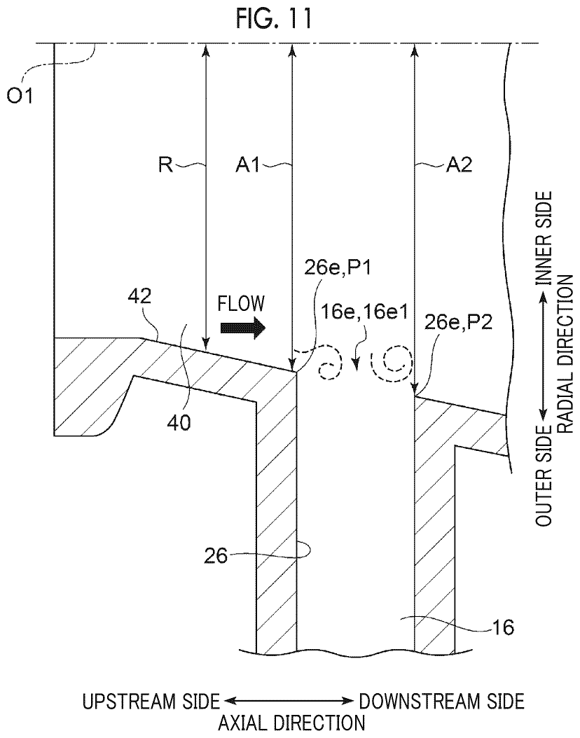

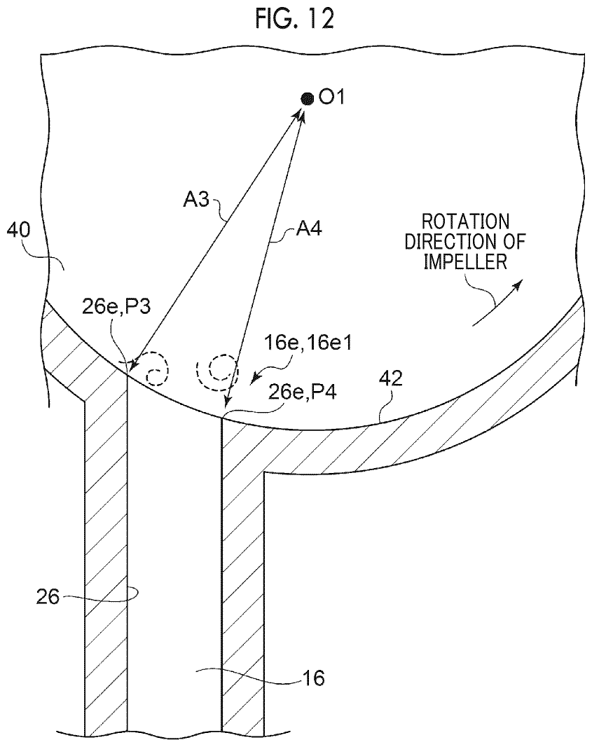

FIG. 11 is a partially enlarged view showing another example of the shape of the connecting portion between the bypass flow path 16 and the compressor inlet flow path 40 in the centrifugal compressor 4 shown in FIG. 1, and shows a part of a cross section (cross section including the axis O1 of the compressor inlet flow path 40) along the axial direction in the vicinity of the outlet portion 16e of the bypass flow path 16. FIG. 12 is a view showing a part of a cross section orthogonal to the axial direction at a position of the bypass flow path 16 with respect to the centrifugal compressor 4 shown in FIG. 11.

In some embodiments, for example, as shown in FIG. 11, in a section including a portion connected to the bypass flow path 16 in the compressor inlet flow path 40, a distance R between the flow path wall surface 42 of the compressor inlet flow path 40 and the axis O1 of the compressor inlet flow path 40 may increase toward the downstream side in the axial direction. In addition, in the exemplary embodiment shown in FIGS. 11 and 12, with respect to the end edge 26e of the bypass flow path 16 on the side of the outlet 16e1 in the flow path wall surface 26 of the bypass flow path 16, when a distance between the most upstream position P1 in the axial direction in the end edge 26e and the axis O1 of the compressor inlet flow path 40 is denoted as A1, a distance between the most downstream position P2 in the axial direction in the end edge 26e and the axis O1 is denoted as A2, a distance between the most upstream position P3 in the rotation direction of the impeller 6 in the end edge 26e and the axis O1 of the compressor inlet flow path 40 is denoted as A3, and a distance between the most downstream position P4 in the rotation direction of the impeller 6 in the end edge 26e and the axis O1 is denoted as A4, A1<A2 and A3<A4 are satisfied.

Also in the embodiments shown in FIGS. 11 and 12, noise generated at the outlet 16e1 of the bypass flow path 16 can be effectively reduced even when the flow rate changes. In addition, since it is not necessary to increase the area of the outlet 16e1 of the bypass flow path 16, noise can be reduced while the influence on the performance of the centrifugal compressor 4 is suppressed.

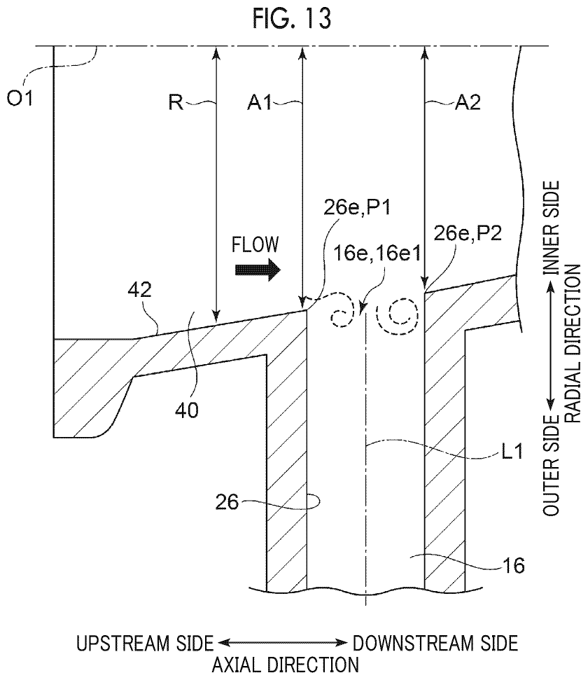

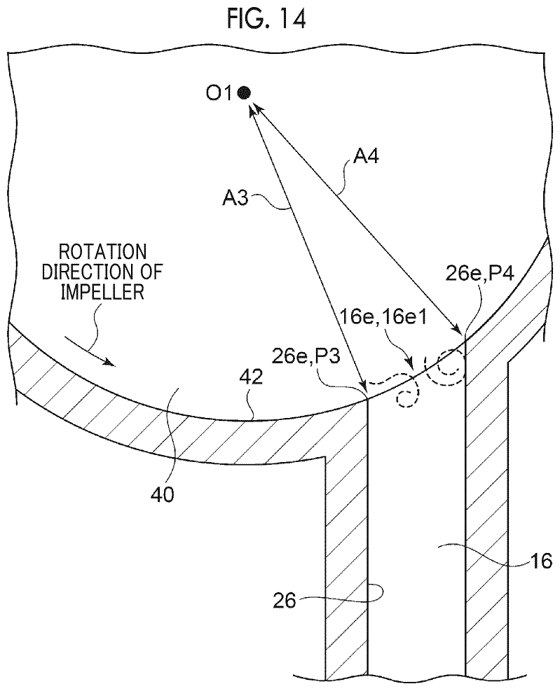

FIG. 13 is a partially enlarged view showing another example of the shape of the connecting portion between the bypass flow path 16 and the compressor inlet flow path 40 in the centrifugal compressor 4 shown in FIG. 1, and shows a part of a cross section (cross section including the axis O1 of the compressor inlet flow path 40) along the axial direction in the vicinity of the outlet portion 16e of the bypass flow path 16. FIG. 14 is a view showing a part of a cross section orthogonal to the axial direction at a position of the bypass flow path 16 with respect to the centrifugal compressor 4 shown in FIG. 13.

In some embodiments, for example, as shown in FIG. 13, in a section including a portion connected to the bypass flow path 16 in the compressor inlet flow path 40, the distance R between the flow path wall surface 42 of the compressor inlet flow path 40 and the axis O1 of the compressor inlet flow path 40 may decrease toward the downstream side in the axial direction. In addition, in the exemplary embodiment shown in FIGS. 13 and 14, with respect to the end edge 26e of the bypass flow path 16 on the side of the outlet 16e1 in the flow path wall surface 26 of the bypass flow path 16, when a distance between the most upstream position P1 in the axial direction in the end edge 26e and the axis O1 of the compressor inlet flow path 40 is denoted as A1, a distance between the most downstream position P2 in the axial direction in the end edge 26e and the axis O1 is denoted as A2, a distance between the most upstream position P3 in the rotation direction of the impeller 6 in the end edge 26e and the axis O1 of the compressor inlet flow path 40 is denoted as A3, and a distance between the most downstream position P4 in the rotation direction of the impeller 6 in the end edge 26e and the axis O1 is denoted as A4, A1>A2 and A3>A4 are satisfied.

Also in the embodiments shown in FIGS. 13 and 14, noise generated at the outlet 16e1 of the bypass flow path 16 can be effectively reduced even when the flow rate changes. In addition, since it is not necessary to increase the area of the outlet 16e1 of the bypass flow path 16, noise can be reduced while the influence on the performance of the centrifugal compressor 4 is suppressed.

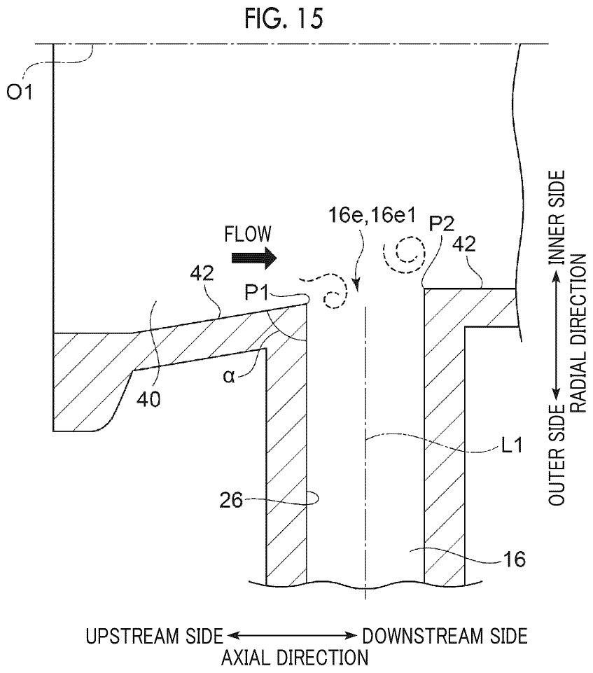

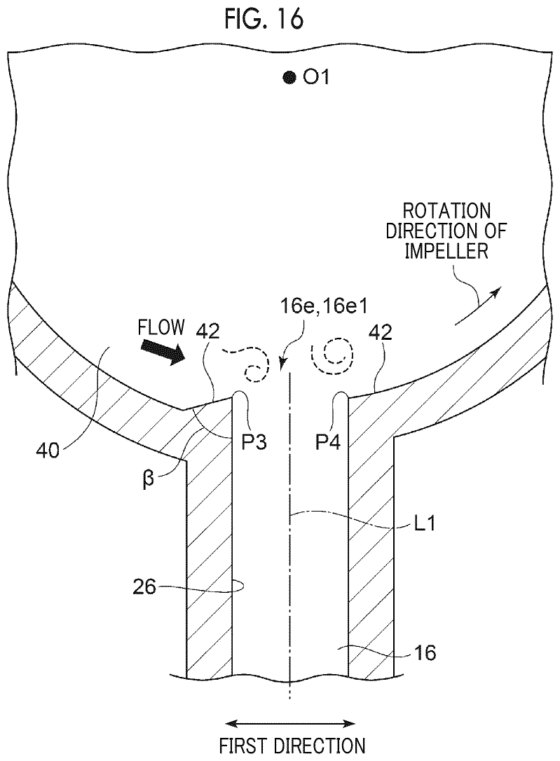

FIG. 15 is a partially enlarged view showing another example of the shape of the connecting portion between the bypass flow path 16 and the compressor inlet flow path 40 in the centrifugal compressor 4 shown in FIG. 1, and shows a part of a cross section (cross section including the axis O1 of the compressor inlet flow path 40) along the axial direction in the vicinity of the outlet portion 16e of the bypass flow path 16. FIG. 16 is a view showing a part of a cross section orthogonal to the axial direction at a position of the axis L1 of the bypass flow path 16 with respect to the centrifugal compressor 4 shown in FIG. 15.

In some embodiments, for example, as shown in FIGS. 15 and 16, in a cross section along the axial direction, an angle α formed between the flow path wall surface 42 of the compressor inlet flow path 40 and the flow path wall surface 26 of the bypass flow path 16 on the upstream side of the axis L1 of the bypass flow path 16 in the axial direction is less than 90 degrees, and in a cross section orthogonal to the axial direction, an angle θ formed between the flow path wall surface 42 of the compressor inlet flow path 40 and the flow path wall surface 26 of the bypass flow path 16 on the upstream side of the axis L1 of the bypass flow path 16 in the rotation direction of the impeller 6 is less than 90 degrees. In addition, in the exemplary embodiment shown in FIGS. 15 and 16, in a cross section along the axial direction, an angle formed between the flow path wall surface 42 of the compressor inlet flow path 40 and the flow path wall surface 26 of the bypass flow path 16 on the downstream side of the axis L1 of the bypass flow path 16 in the axial direction is 90 degrees, and in a cross section orthogonal to the axial direction, an angle formed between the flow path wall surface 42 of the compressor inlet flow path 40 and the flow path wall surface 26 of the bypass flow path 16 on the downstream side of the axis L1 of the bypass flow path 16 in the rotation direction of the impeller 6 is larger than 90 degrees.

In the embodiment shown in FIGS. 15 and 16, the angle α is less than 90 degrees, so that under the operating condition on the high flow rate side in the centrifugal compressor 4, when the air (main flow) flowing through the compressor inlet flow path 40 along the axial direction passes through the outlet 16e1 of the bypass flow path 16, even if a vortex is generated at the position P1 (position of the leading edge of the outlet with respect to the flow in the axial direction) of the end edge on the upstream side in the axial direction at the outlet 16e1, it is possible to suppress or avoid collision of the vortex with the position P2 (position of the trailing edge of the outlet with respect to the flow in the axial direction) of the end edge on the downstream side in the axial direction at the outlet 16e1 of the bypass flow path 16, and it is possible to suppress pressure fluctuations caused by the collision to reduce noise at the outlet 16e1 of the bypass flow path 16.

In addition, the angle β is smaller than 90 degrees, so that under the operating condition on the low flow rate side in the centrifugal compressor 4, when the swirling flow of the air flowing through the compressor inlet flow path 40 passes through the outlet 16e1 of the bypass flow path 16, even if a vortex is generated at the position P3 (position of the leading edge of the outlet 16e1 with respect to the swirling flow in the rotation direction of the impeller 6) of the end edge on the upstream side in the rotation direction of the impeller 6 at the outlet 16e1, it is possible to suppress or avoid collision of the vortex with the position P4 (position of the trailing edge of the outlet 16e1 with respect to the swirling flow in the rotation direction of the impeller 6) of the end edge on the downstream side in the rotation direction at the outlet 16e1 of the bypass flow path 16, and it is possible to suppress pressure fluctuations caused by the collision to reduce noise at the outlet 16e1 of the bypass flow path 16.

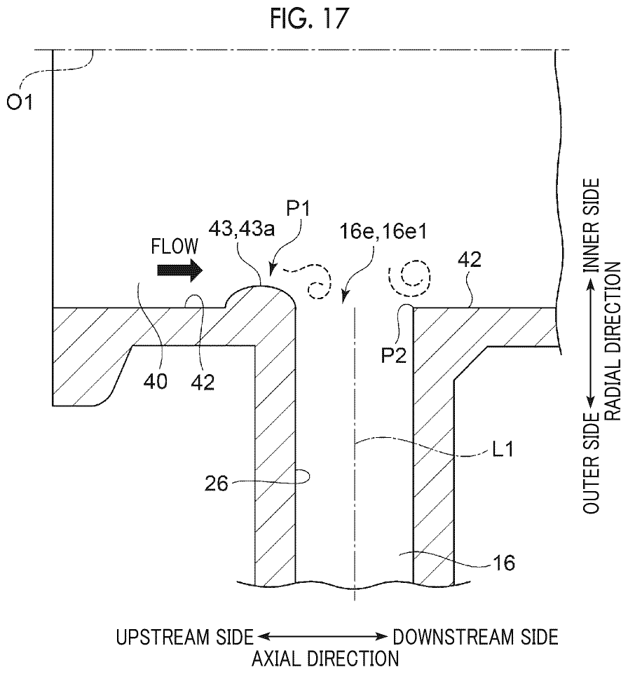

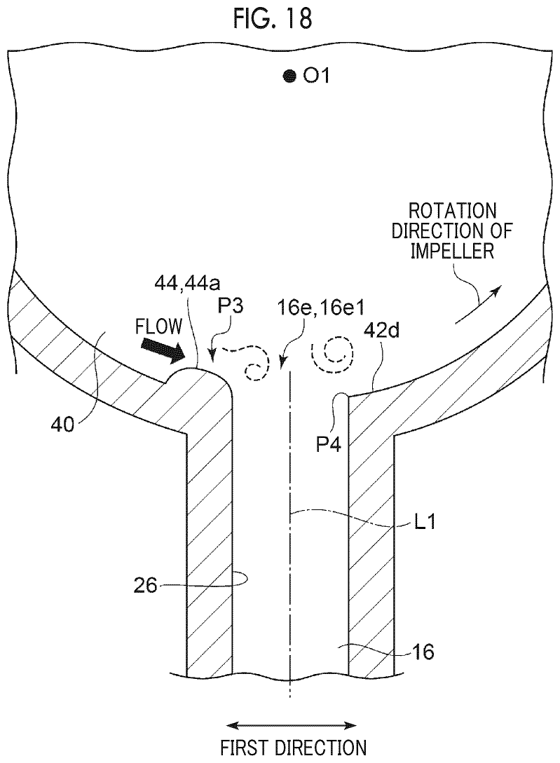

FIG. 17 is a partially enlarged view showing another example of the shape of the connecting portion between the bypass flow path 16 and the compressor inlet flow path 40 in the centrifugal compressor 4 shown in FIG. 1, and shows a part of a cross section (cross section including the axis O1 of the compressor inlet flow path 40) along the axial direction in the vicinity of the outlet portion 16e of the bypass flow path 16. FIG. 18 is a view showing a part of a cross section orthogonal to the axial direction at a position of the axis L1 of the bypass flow path 16 with respect to the centrifugal compressor 4 shown in FIG. 17.

In some embodiments, for example, as shown in FIGS. 17 and 18, in a cross section along the axial direction, the flow path wall surface 42 of the compressor inlet flow path 40 includes a first convex portion 43 at a position on the upstream side in the axial direction with respect to the outlet 16e1 of the bypass flow path 16, and in a cross section orthogonal to the axial direction, the flow path wall surface 42 of the compressor inlet flow path 40 includes a second convex portion 44 at a position on the upstream side in the rotation direction of the impeller 6 with respect to the outlet 16e1 of the bypass flow path 16.

In the illustrated exemplary embodiment, in a cross section along the axial direction, the first convex portion 43 includes a rounded convex curve 43a, and in a cross section orthogonal to the axial direction, the second convex portion 44 includes a rounded convex curve 44a. In addition, a distance between the first convex portion 43 and the outlet 16e1 of the bypass flow path 16 is smaller than the flow path width W1 of the bypass flow path 16 in the axial direction at a position of the outlet 16e1 of the bypass flow path 16. In the illustrated exemplary embodiment, the distance between the first convex portion 43 and the outlet 16e1 of the bypass flow path 16 is 0, and the first convex portion 43 is provided adjacent to the outlet 16e1 on the upstream side of the outlet 16e1 of the bypass flow path 16 in the axial direction. In addition, a distance between the second convex portion 44 and the outlet 16e1 of the bypass flow path 16 is smaller than the flow path width W2 of the bypass flow path 16 in the first direction at a position of the outlet 16e1 of the bypass flow path 16. In the illustrated exemplary embodiment, the distance between the second convex portion 44 and the outlet 16e1 of the bypass flow path 16 is 0, and the second convex portion 44 is provided adjacent to the outlet 16e1 on the upstream side of the outlet 16e1 of the bypass flow path 16 in the rotation direction of the impeller 6. The first convex portion 43 extends along the circumferential direction, and the second convex portion 44 extends along the axial direction. In addition, an upstream end of the first convex portion 43 in the rotation direction of the impeller 6 and an upstream end of the second convex portion 44 in the axial direction may be connected to each other.

In the embodiments shown in FIGS. 17 and 18, in a cross section along the axial direction, the flow path wall surface 42 of the compressor inlet flow path 40 includes the first convex portion 43 at a position on the upstream side in the axial direction with respect to the outlet 16e1 of the bypass flow path 16, so that under the operating condition on the high flow rate side in the centrifugal compressor 4, when the air (main flow) flowing through the compressor inlet flow path 40 along the axial direction passes through the outlet 16e1 of the bypass flow path 16, even if a vortex is generated at the position P1 of the first convex portion 43 on the upstream side in the axial direction at the outlet 16e1, it is possible to suppress or avoid collision of the vortex with the position P2 (position of the trailing edge of the outlet with respect to the flow in the axial direction) of the end edge on the downstream side in the axial direction at the outlet 16e1 of the bypass flow path 16, and it is possible to suppress pressure fluctuations caused by the collision to reduce noise at the outlet 16e1 of the bypass flow path 16.

In addition, in a cross section orthogonal to the axial direction, the flow path wall surface 42 of the compressor inlet flow path 40 includes the second convex portion 44 at a position on the upstream side in the rotation direction of the impeller 6 with respect to the outlet 16e1 of the bypass flow path 16, so that under the operating condition on the low flow rate side in the centrifugal compressor 4, when the swirling flow of the air flowing through the compressor inlet flow path 40 passes through the outlet 16e1 of the bypass flow path 16, even if a vortex is generated at the position P3 of the second convex portion 44 on the upstream side in the rotation direction of the impeller 6 at the outlet 16e1, it is possible to suppress or avoid collision the vortex with the position P4 (position of the trailing edge of the outlet 16e1 with respect to the swirling flow in the rotation direction of the impeller 6) of the end edge on the downstream side in the rotation direction at the outlet 16e1 of the bypass flow path 16, and it is possible to suppress pressure fluctuations caused by the collision to reduce noise at the outlet 16e1 of the bypass flow path 16.

The present disclosure is not limited to the above-described embodiments, and includes modifications of the above-described embodiments and a combination of these embodiments as appropriate.

For example, in the configuration shown in FIG. 2 or FIG. 4, in a cross section along the axial direction, an angle formed between the flow path wall surface 26 of the bypass flow path 16 and the flow path wall surface 42 of the compressor inlet flow path 40 is 90 degrees on the upstream side of the axis L1 of the bypass flow path 16 in the axial direction, but in the outlet portion 16e of the bypass flow path 16, the flow path wall surface 26 of the bypass flow path 16 may include an inclined surface that is inclined toward the upstream side in the axial direction as the inclined surface approaches the compressor inlet flow path 40 (as it moves toward the inner side in the radial direction) on the upstream side of the axis L1 in the axial direction.

In addition, also in the configuration shown in FIG. 3 or 5, in the outlet portion 16e of the bypass flow path 16, the flow path wall surface 26 of the bypass flow path 16 may include an inclined surface that is inclined toward the upstream side in the rotation direction of the impeller 6 as the inclined surface approaches the compressor inlet flow path 40 (as it moves toward the inner side in the radial direction) on the upstream side of the axis L1 in the rotation direction of the impeller 6.

In addition, in some of the above-described embodiments, the bypass flow path 16 is exemplified as the fluid introduction flow path for introducing the fluid into the compressor inlet flow path 40, but the fluid introduction flow path may be, for example, an EGR flow path (exhaust gas recirculation flow path) that returns the exhaust gas of an engine to the compressor inlet flow path.

The contents described in each embodiment are understood as follows, for example.

(1) A centrifugal compressor (for example, the centrifugal compressor 4 described above) according to at least one embodiment of the present disclosure includes
an impeller (for example, the impeller 6 described above), a compressor inlet flow path (for example, the compressor inlet flow path 40 described above) that guides a fluid to the impeller, and
a fluid introduction flow path (for example, the bypass flow path 16 described above or an EGR flow path that returns exhaust gas of an engine to the compressor inlet flow path) that is connected to the compressor inlet flow path in a direction intersecting an axis of the compressor inlet flow path and that introduces the fluid into the compressor inlet flow path, in which
at an outlet portion (for example, the outlet portion 16e described above) of the bypass flow path, a flow path wall surface (for example, the flow path wall surface 26 described above) of the bypass flow path includes
a first inclined surface (for example, the first inclined surfaces 28 and 34 described above) that is located on a downstream side in an axial direction of the impeller with respect to an axis of the bypass flow path and that is inclined toward the downstream side in the axial direction as the first inclined surface approaches the compressor inlet flow path, and
a second inclined surface (for example, the second inclined surfaces 30 and 36 described above) that is located on a downstream side in a rotation direction of the impeller with respect to the axis of the bypass flow path and that is inclined toward the downstream side in the rotation direction as the second inclined surface approaches the compressor inlet flow path.

Under the operating condition on the high flow rate side in the centrifugal compressor, a fluid is guided to the compressor inlet flow path and flows along the axial direction of the impeller, and the swirling component in the rotation direction of the impeller in the flow in the compressor inlet flow path is relatively small. On the other hand, under the operating condition on the low flow rate side in the centrifugal compressor, the influence of the rotation of the impeller on the flow in the compressor inlet flow path becomes larger, and the swirling component in the rotation direction of the impeller in the flow in the compressor inlet flow path becomes relatively large.

In this regard, in the centrifugal compressor described in (1) above, in the outlet portion of the bypass flow path, the flow path wall surface of the bypass flow path includes the first inclined surface on the downstream side in the axial direction with respect to the axis of the bypass flow path. For this reason, under the operating condition on the high flow rate side in the centrifugal compressor, when the air (main flow) flowing through the compressor inlet flow path along the axial direction passes through an outlet of the bypass flow path, even if a vortex is generated at a position (position of the leading edge of the outlet with respect to the flow in the axial direction) of the end edge on the upstream side in the axial direction at the outlet, compared to a case where the flow path wall surface of the bypass flow path is not inclined with respect to the axis of the bypass flow path, it is possible to alleviate the pressure fluctuation caused by the collision of the vortex with the vicinity of a position (position of the trailing edge of the outlet with respect to the flow in the axial direction) of the end edge on the downstream side in the axial direction at the outlet of the bypass flow path, and it is possible to reduce noise generated at the outlet of the bypass flow path.

In addition, in the outlet portion of the bypass flow path, the flow path wall surface of the bypass flow path includes the second inclined surface on the downstream side in the rotation direction of the impeller with respect to the axis of the bypass flow path. Therefore, under the operating condition on the low flow rate side in the centrifugal compressor, when the swirling flow of the air flowing through the compressor inlet flow path passes through the outlet of the bypass flow path, even if a vortex is generated at a position (position of the leading edge of the outlet with respect to the swirling flow in the rotation direction of the impeller) of the end edge on the upstream side in the rotation direction of the impeller at the outlet, compared to a case where the flow path wall surface of the bypass flow path is not inclined with respect to the axis of the bypass flow path, it is possible to alleviate the pressure fluctuation caused by the collision of the vortex with the vicinity of a position (position of the trailing edge of the outlet with respect to the swirling flow in the rotation direction of the impeller) of the end edge on the downstream side in the rotation direction of the impeller at the outlet, and it is possible to reduce noise generated at the outlet of the bypass flow path.

In addition, for example, regarding the embodiment shown in FIGS. 17 and 18, the first convex portion 43 may be provided at a position slightly separated from the outlet 16e1 of the bypass flow path 16 (for example, a position within the flow path width W1 from the outlet 16e1) to the upstream side in the axial direction, and the second convex portion 44 may be provided at a position slightly separated from the outlet 16e1 of the bypass flow path 16 (for example, a position within the flow path width W2 from the outlet 16e1) to the upstream side in the rotation direction of the impeller 6.

Therefore, according to the centrifugal compressor described in (1) above, noise generated at the outlet of the bypass flow path can be effectively reduced even when the flow rate changes.

(2) In some embodiments, in the centrifugal compressor described in (1) above, in a cross section along the axial direction, the first inclined surface includes a straight line (for example, the straight line 28a described above), and in a cross section orthogonal to the axial direction, the second inclined surface includes a straight line (for example, the straight line 30a described above).

According to the centrifugal compressor described in (2) above, even when the flow rate changes, noise generated at the outlet of the bypass flow path can be effectively reduced.

(3) In some embodiments, in the centrifugal compressor described in (1) above, in a cross section along the axial direction, the first inclined surface includes a convex curve (for example, the convex curve 34a described above), and in a cross section orthogonal to the axial direction, the second inclined surface includes a convex curve (for example, the convex curve 36a described above).

According to the centrifugal compressor described in (3) above, even when the flow rate changes, noise generated at the outlet of the bypass flow path can be effectively reduced.

(4) In some embodiments, in the centrifugal compressor described in the any one of (1) to (3) above,
when a dimension of the first inclined surface in the axial direction is denoted as E1, and a flow path width in the axial direction of a flow path portion adjacent to an upstream side of the first inclined surface in the bypass flow path is denoted as E2, E1≥0.1×E2 is satisfied.

According to the centrifugal compressor described in (4) above, even when the flow rate changes, noise generated at the outlet of the bypass flow path can be effectively reduced.

(5) In some embodiments, in the centrifugal compressor described in any one of (1) to (4) above,
when a direction orthogonal to each of the axial direction and the axis of the bypass flow path is defined as a first direction, a dimension of the second inclined surface in the first direction is denoted as E3, and a flow path width in the first direction of a flow path portion adjacent to an upstream side of the second inclined surface in the bypass flow path is denoted as E4, E3≥0.1×E4 is satisfied.

According to the centrifugal compressor described in (5) above, even when the flow rate changes, noise generated at the outlet of the bypass flow path can be effectively reduced.

(6) A centrifugal compressor according to at least one embodiment of the present disclosure includes
an impeller (for example, the impeller 6 described above),
a compressor inlet flow path (for example, the compressor inlet flow path 40 described above) that guides a fluid to the impeller, and
a fluid introduction flow path (for example, the bypass flow path 16 described above or an EGR flow path that returns exhaust gas of an engine to the compressor inlet flow path) that is connected to the compressor inlet flow path in a direction intersecting an axis of the compressor inlet flow path and that introduces the fluid into the compressor inlet flow path, in which
with respect to an end edge (for example, the end edge 26e described above) on a side of the compressor inlet flow path in a flow path wall surface of the fluid introduction flow path, when a distance between a most upstream position (for example, the most upstream position P1 described above) in an axial direction of the impeller in the end edge and the axis of the compressor inlet flow path is denoted as A1, a distance between a most downstream position (for example, the most downstream position P2 described above) in the axial direction in the end edge and the axis is denoted as A2, a distance between a most upstream position (for example, the most upstream position P3 described above) in a rotation direction of the impeller in the end edge and the axis is denoted A3, and a distance between a most downstream position (for example, the most downstream position P4 described above) in the rotation direction in the end edge and the axis is denoted as A4, A1 and A2 are different from each other, and A3 and A4 are different from each other.

Under the operating condition on the high flow rate side in the centrifugal compressor, a fluid is guided to the compressor inlet flow path and flows along the axial direction of the impeller, and the swirling component in the rotation direction of the impeller in the flow in the compressor inlet flow path is relatively small. On the other hand, under the operating condition on the low flow rate side in the centrifugal compressor, the influence of the rotation of the impeller on the flow in the compressor inlet flow path becomes larger, and the swirling component in the rotation direction of the impeller in the flow in the compressor inlet flow path becomes relatively large.

In contrast, in the centrifugal compressor described in (6) above, the distance A1 and the distance A2 are different from each other, so that, with respect to the end edge on the side of the compressor inlet flow path in the flow path wall surface of the fluid introduction flow path, a step is formed in the radial direction of the impeller between the most upstream position in the axial direction of the impeller in the end edge and the most downstream position in the axial direction of the impeller in the end edge. Therefore, under the operating condition on the high flow rate side in the centrifugal compressor, when the swirling flow of the fluid flowing through the compressor inlet flow path passes through the outlet of the fluid introduction flow path, even if a vortex is generated at a position (position of the leading edge of the outlet with respect to the flow in the axial direction) of the end edge on the upstream side in the axial direction of the impeller at the outlet, it is possible to suppress or avoid collision of the vortex with the postion of the end edge (position of the trailing edge of the outlet with respect to the flow in the axial direction) on the downstream side in the axial direction of the impeller at the outlet of the fluid introduction flow path, and it is possible to alleviate the pressure fluctuation caused by the collision to reduce noise at the outlet of the fluid introduction flow path.

In addition, in the centrifugal compressor described in (6) above, the distance A3 and the distance A4 are different from each other, so that, with respect to the end edge on the side of the compressor inlet flow path in the flow path wall surface of the fluid introduction flow path, a step is formed in the radial direction of the impeller between the most upstream position in the rotation direction of the impeller in the end edge and the most downstream position in the rotation direction of the impeller in the end edge. Therefore, under the operating condition on the low flow rate side in the centrifugal compressor, when the swirling flow of the fluid flowing through the compressor inlet flow path passes through the outlet of the fluid introduction flow path, even if a vortex is generated at a position (position of the leading edge of the outlet with respect to the swirling flow in the rotation direction of the impeller) of the end edge on the upstream side in the rotation direction of the impeller at the outlet, it is possible to suppress or avoid collision of the vortex with the postion of the end edge (position of the trailing edge of the outlet with respect to the swirling flow in the rotation direction of the impeller) on the downstream side in the rotation direction of the impeller at the outlet of the fluid introduction flow path, and it is possible to alleviate the pressure fluctuation caused by the collision to reduce noise at the outlet of the fluid introduction flow path.

Therefore, even when the flow rate changes, noise generated at the outlet of the fluid introduction flow path can be effectively reduced. In addition, since it is not necessary to increase the area of the outlet of the fluid introduction flow path, noise can be reduced while the influence on the performance of the centrifugal compressor is suppressed.

(7) In some embodiments, in the centrifugal compressor described in (6) above, A1<A2 and A3<A4 are satisfied.

According to the centrifugal compressor described in (7) above, compared to a case where both A1>A2 and A3>A4 are satisfied, noise generated at the outlet of the fluid introduction flow path can be more effectively reduced even when a flow rate changes.

(8) In some embodiments, in the centrifugal compressor described in (6) or (7) above,
in a section including a connecting portion connected to the fluid introduction flow path in the compressor inlet flow path, a distance (for example, the distance R described above) between the flow path wall surface of the compressor inlet flow path and the axis of the compressor inlet flow path increases toward a downstream side in the axial direction.

According to the centrifugal compressor described in (8) above, even when the flow rate changes, noise generated at the outlet of the fluid introduction flow path can be effectively reduced. In addition, since it is not necessary to increase the area of the outlet of the fluid introduction flow path, noise can be reduced while the influence on the performance of the centrifugal compressor is suppressed.

(9) In some embodiments, in the centrifugal compressor described in (6) or (7) above,
in a section including a connecting portion connected to the fluid introduction flow path in the compressor inlet flow path, a distance (for example, the distance R described above) between the flow path wall surface of the compressor inlet flow path and the axis of the compressor inlet flow path decreases toward a downstream side in the axial direction.

According to the centrifugal compressor described in (9) above, even when the flow rate changes, noise generated at the outlet of the fluid introduction flow path can be effectively reduced. In addition, since it is not necessary to increase the area of the outlet of the fluid introduction flow path, noise can be reduced while the influence on the performance of the centrifugal compressor is suppressed.

(10) In some embodiments, in the centrifugal compressor described in (7) above,
When a direction orthogonal to each of the axial direction and the axis of the fluid introduction flow path is defined as a first direction, and a flow path width of the fluid introduction flow path in the first direction at a position of an outlet of the fluid introduction flow path is denoted as W (for example, W2 described above), Expression (a) below is satisfied:

$$\vert A 3 - A 4 \vert \geq 0. 35 \times W . \qquad Expression ( a )$$

The larger the flow path width W is, the deeper the flow along the circumferential direction of the impeller in the compressor inlet flow path penetrates into the fluid introduction flow path, and the wider the range of collision with the flow path wall surface of the fluid introduction flow path is. In this regard, by satisfying the above Expression (a) as in the centrifugal compressor of (10) above, it is possible to effectively suppress the collision of the vortex with the flow path wall surface of the fluid introduction flow path and to suppress noise caused by the collision of the vortex.

(11) In some embodiments, in the centrifugal compressor described in (7) above,
when a direction orthogonal to each of the axial direction and an axis of the fluid introduction flow path is defined as a first direction, a flow path width of the fluid introduction flow path in the first direction at a position of an outlet of the fluid introduction flow path is denoted as W (for example, W2 described above), and an extent of an angle range in which the outlet of the fluid introduction flow path is present in a circumferential direction of the impeller is denoted as θ, Expression (b) below is satisfied:

$$\vert A 3 - A 4 \vert > W \times tan ( θ / 2 ) . \qquad Expression ( b )$$

When an imaginary line extending in a tangential direction of a circle configuring the flow path wall surface of the compressor inlet flow path from a position of the end edge on the upstream side in the rotation direction of the impeller at the outlet of the fluid introduction flow path in a cross section orthogonal to the axial direction is denoted as L2, in a case where the above Expression (b) is satisfied, a position of the end edge on the downstream side in the rotation direction of the impeller at the outlet in the cross section orthogonal to the axial direction is on the outer side in the radial direction with respect to the imaginary line L2. Therefore, when the swirling flow of the fluid flowing through the compressor inlet flow path passes through the outlet of the fluid introduction flow path, even if a vortex is generated at a position (leading edge of the outlet with respect to the swirling flow in the rotation direction of the impeller) of the end edge on the upstream side in the rotation direction of the impeller at the outlet, it is possible to suppress or avoid collision of the vortex with the position of the end edge (position of the trailing edge of the outlet with respect to the swirling flow in the rotation direction of the impeller) on the downstream side in the rotation direction at the outlet of the fluid introduction flow path, and it is possible to effectively suppress noise caused by the collision of the vortex.

(12) A centrifugal compressor according to at least one embodiment of the present disclosure includes
an impeller (for example, the impeller 6 described above),
a compressor inlet flow path (for example, the compressor inlet flow path 40 described above) that guides a fluid to the impeller, and
a fluid introduction flow path (for example, the bypass flow path 16 described above or an EGR flow path that returns exhaust gas of an engine to the compressor inlet flow path) that is connected to the compressor inlet flow path in a direction intersecting an axis of the compressor inlet flow path and that introduces the fluid into the compressor inlet flow path, in which
Condition (A) below or Condition (B) below is satisfied:
Condition (A): in a cross section along an axial direction of the impeller, an angle (for example, the angle α described above) formed between a flow path wall surface of the compressor inlet flow path and a flow path wall surface of the fluid introduction flow path on an upstream side of an axis of the fluid introduction flow path in the axial direction is less than 90 degrees, and in a cross section orthogonal to the axial direction of the impeller, an angle (for example, the angle β described above) formed between the flow path wall surface of the compressor inlet flow path and the flow path wall surface of the fluid introduction flow path on an upstream side of the axis of the fluid introduction flow path in a rotation direction of the impeller is less than 90 degrees; and
Condition (B): in a cross section along the axial direction of the impeller, the flow path wall surface of the compressor inlet flow path includes a first convex portion (for example, the first convex portion 43 described above) at a position on an upstream side in the axial direction with respect to an outlet of the fluid introduction flow path, and in a cross section orthogonal to the axial direction of the impeller, the flow path wall surface of the compressor inlet flow path includes a second convex portion (for example, the second convex portion 44 described above) at a position on an upstream side in the rotation direction of the impeller with respect to the outlet of the fluid introduction flow path.

Under the operating condition on the high flow rate side in the centrifugal compressor, a fluid is guided to the compressor inlet flow path and flows along the axial direction of the impeller, and the swirling component in the rotation direction of the impeller in the flow in the compressor inlet flow path is relatively small. On the other hand, under the operating condition on the low flow rate side in the centrifugal compressor, the influence of the rotation of the impeller on the flow in the compressor inlet flow path becomes larger, and the swirling component in the rotation direction of the impeller in the flow in the compressor inlet flow path becomes relatively large.

In contrast, in the case of the centrifugal compressor satisfying Condition (A) or Condition (B) of (12) above, under the operating condition on the high flow rate side, when the swirling flow of the fluid flowing through the compressor inlet flow path passes through the outlet of the fluid introduction flow path, even if a vortex is generated at the end edge (position of the leading edge of the outlet with respect to the flow in the axial direction) on the upstream side in the axial direction of the impeller at the outlet, it is possible to suppress or avoid collision of the vortex with the position of the end edge (position of the trailing edge of the outlet with respect to the flow in the axial direction) on the downstream side in the axial direction of the impeller at the outlet of the fluid introduction flow path, and it is possible to alleviate the pressure fluctuation caused by the collision to reduce noise at the outlet of the fluid introduction flow path. In addition, in the centrifugal compressor that satisfies Condition (A) or Condition (B) of (12) above, under the operating condition on the low flow rate side in the centrifugal compressor, when the swirling flow of the fluid flowing through the compressor inlet flow path passes through the outlet of the fluid introduction flow path, even if a vortex is generated in the end edge (position of the leading edge of the outlet with respect to the swirling flow in the rotation direction of the impeller) on the upstream side in the rotation direction of the impeller at the outlet, it is possible to suppress or avoid collision of the vortex with the position of the end edge (position of the trailing edge of the outlet with respect to the swirling flow in the rotation direction of the impeller) on the downstream side in the rotation direction of the impeller at the outlet of the fluid introduction flow path, and it is possible to alleviate the pressure fluctuation caused by the collision to reduce noise at the outlet of the fluid introduction flow path.

Therefore, even when the flow rate changes, noise generated at the outlet of the fluid introduction flow path can be effectively reduced. In addition, since it is not necessary to increase the area of the outlet of the fluid introduction flow path, noise can be reduced while the influence on the performance of the centrifugal compressor is suppressed.

(13) In some embodiments, in the centrifugal compressor described in (12) above,
Condition (B) above is satisfied, and the first convex portion includes a convex curve (for example, the convex curve 43a described above) in a cross section along the axial direction, and the second convex portion includes a convex curve (for example, the convex curve 44a described above) in a cross section orthogonal to the axial direction.

According to the centrifugal compressor described in (13) above, even when the flow rate changes, noise generated at the outlet of the fluid introduction flow path can be effectively reduced. In addition, since it is not necessary to increase the area of the outlet of the fluid introduction flow path, noise can be reduced while the influence on the performance of the centrifugal compressor is suppressed.

(14) In some embodiments, in the centrifugal compressor described in (12) above,
Condition (B) above is satisfied, a distance between the first convex portion and the outlet of the fluid introduction flow path is smaller than a flow path width of the fluid introduction flow path in the axial direction at a position of the outlet of the fluid introduction flow path, and
when a direction orthogonal to each of the axial direction and the axis of the fluid introduction flow path is defined as a first direction, a distance between the second convex portion and the outlet of the fluid introduction flow path is smaller than a flow path width of the fluid introduction flow path in the first direction at the position of the outlet of the fluid introduction flow path.

According to the centrifugal compressor described in (14) above, each of the first convex portion and the second convex portion is disposed in the vicinity of the outlet of the fluid introduction flow path to the extent described in (14) above, so that noise generated at the outlet of the fluid introduction flow path can be more effectively reduced.

(15) In some embodiments, in the centrifugal compressor described in any one of (1) to (14) above,
the centrifugal compressor further includes a valve (for example, the bypass valve 18 described above or an EGR valve provided in an EGR flow path) provided in an intermediate portion of the fluid introduction flow path, in which
the valve seat surface (for example, the valve seat surface 27 described above) on which the valve abuts is formed on the flow path wall surface of the fluid introduction flow path, and when a flow path area of an outlet of the fluid introduction flow path is denoted as Sp, and a flow path area of the fluid introduction flow path at a position of the valve seat surface is denoted as Sq, Sp>Sq is satisfied.

According to the centrifugal compressor described in (15) above, noise generated at the outlet of the fluid introduction flow path can be reduced while the influence on the performance of the centrifugal compressor is suppressed.

(16) In some embodiments, in the centrifugal compressor described in any one of (1) to (15) above, when a flow path area of an outlet of the fluid introduction flow path is Sp, and a flow path area of the compressor inlet flow path at a position of the outlet is denoted as Sv, Sp<0.35×Sv is satisfied.

According to the centrifugal compressor described in (16) above, noise generated at the outlet of the fluid introduction flow path can be reduced while the influence on the performance of the centrifugal compressor is suppressed.

(17) A turbocharger according to at least one embodiment of the present disclosure includes
the centrifugal compressor described in any one of (1) to (16) above, and a turbine (for example, the turbine 12 described above) connected to the centrifugal compressor.

According to the turbocharger described in (17) above, since the centrifugal compressor described in any one of (1) to (16) above is provided, even when the flow rate changes, noise generated at the outlet of the fluid introduction flow path can be effectively reduced.

### REFERENCE SIGNS LIST

2: turbocharger
4: centrifugal compressor
6: impeller
8: rotary shaft
10: turbine rotor
12: turbine
14: scroll flow path
16: bypass flow path
16e1: outlet
16e: outlet portion
16u: flow path portion
18: bypass valve
19: actuator
22: valve port
24: end portion
26, 42: flow path wall surface
26e: end edge
27: valve seat surface
28, 34: first inclined surface
28a, 30a: straight line
30, 36: second inclined surface
34a, 36a, 43a, 44a: convex curve
37: compressor inlet pipe
38: outlet pipe
40: compressor inlet flow path
43: first convex portion
44: second convex portion
A1, A2, A3, A4, R: distance
F: arrow
L1, O1: axis
L2: imaginary line
P1, P3: most upstream position
P2. P4: most downstream position
W1, W2: flow path width

1. A centrifugal compressor comprising:
an impeller;
a compressor inlet flow path that guides a fluid to the impeller; and
a fluid introduction flow path that is connected to the compressor inlet flow path in a direction intersecting an axis of the compressor inlet flow path and that introduces the fluid into the compressor inlet flow path, wherein
at an outlet portion of the fluid introduction flow path, a flow path wall surface of the fluid introduction flow path includes
a first inclined surface that is located on a downstream side in an axial direction of the impeller with respect to an axis of the fluid introduction flow path and that is inclined toward the downstream side in the axial direction as the first inclined surface approaches the compressor inlet flow path, and
a second inclined surface that is located on a downstream side in a rotation direction of the impeller with respect to the axis of the fluid introduction flow path and that is inclined toward the downstream side in the rotation direction as the second inclined surface approaches the compressor inlet flow path.

2. The centrifugal compressor according to claim 1, wherein
in a cross section along the axial direction, the first inclined surface includes a straight line, and
in a cross section orthogonal to the axial direction, the second inclined surface includes a straight line.

3. The centrifugal compressor according to claim 1, wherein
in a cross section along the axial direction, the first inclined surface includes a convex curve, and
in a cross section orthogonal to the axial direction, the second inclined surface includes a convex curve.

4. The centrifugal compressor according to claim 1, wherein
when a dimension of the first inclined surface in the axial direction is denoted as E1, and a flow path width in the axial direction of a flow path portion adjacent to an upstream side of the first inclined surface in the fluid introduction flow path is denoted as E2, E1≥0.1×E2 is satisfied.

5. The centrifugal compressor according to claim 1, wherein
when a direction orthogonal to each of the axial direction and the axis of the fluid introduction flow path is defined as a first direction, a dimension of the second inclined surface in the first direction is denoted as E3, and a flow path width in the first direction of a flow path portion adjacent to an upstream side of the second inclined surface in the fluid introduction flow path is denoted as E4, E3≥0.1×E4 is satisfied.

6. A centrifugal compressor comprising:
an impeller;
a compressor inlet flow path that guides a fluid to the impeller; and
a fluid introduction flow path that is connected to the compressor inlet flow path in a direction intersecting an axis of the compressor inlet flow path and that introduces the fluid into the compressor inlet flow path, wherein
with respect to an end edge on an outlet side of the fluid introduction flow path in a flow path wall surface of the fluid introduction flow path, when a distance between a most upstream position in an axial direction of the impeller in the end edge and the axis of the compressor inlet flow path is denoted as A1, a distance between a most downstream position in the axial direction in the end edge and the axis is denoted as A2, a distance between a most upstream position in a rotation direction of the impeller in the end edge and the axis is denoted as A3, and a distance between a most downstream position in the rotation direction in the end edge and the axis is denoted as A4, A1 and A2 are different from each other, and A3 and A4 are different from each other.

7. The centrifugal compressor according to claim 6, wherein
A1<A2 and A3<A4 are satisfied.

8. The centrifugal compressor according to claim 6, wherein
in a section including a connecting portion connected to the fluid introduction flow path in the compressor inlet flow path, a distance between the flow path wall surface of the compressor inlet flow path and the axis of the compressor inlet flow path increases toward a downstream side in the axial direction.

9. The centrifugal compressor according to claim 6, wherein
in a section including a connecting portion connected to the fluid introduction flow path in the compressor inlet flow path, a distance between the flow path wall surface of the compressor inlet flow path and the axis of the compressor inlet flow path decreases toward a downstream side in the axial direction.

10. The centrifugal compressor according to claim 7, wherein
when a direction orthogonal to each of the axial direction and an axis of the fluid introduction flow path is defined as a first direction, and a flow path width of the fluid introduction flow path in the first direction at a position of an outlet of the fluid introduction flow path is denoted as W, Expression (a) below is satisfied:
$$\vert A 3 - A 4 \vert \geq 0. 35 \times W . \qquad Expression ( a )$$

11. The centrifugal compressor according to claim 7, wherein
when a direction orthogonal to each of the axial direction and an axis of the fluid introduction flow path is defined as a first direction, a flow path width of the fluid introduction flow path in the first direction at a position of an outlet of the fluid introduction flow path is denoted as W, and an extent of an angle range in which the outlet of the fluid introduction flow path is present in a circumferential direction of the impeller is denoted as θ,
Expression (b) below is satisfied:
$$\vert A 3 - A 4 \vert > W \times tan ( θ / 2 ) . \qquad Expression ( b )$$

12. A centrifugal compressor comprising:
an impeller;
a compressor inlet flow path that guides a fluid to the impeller; and
a fluid introduction flow path that is connected to the compressor inlet flow path in a direction intersecting an axis of the compressor inlet flow path and that introduces the fluid into the compressor inlet flow path, wherein
Condition (A) below or Condition (B) below is satisfied:
Condition (A): in a cross section along an axial direction of the impeller, an angle formed between a flow path wall surface of the compressor inlet flow path and a flow path wall surface of the fluid introduction flow path on an upstream side of an axis of the fluid introduction flow path in the axial direction is less than 90 degrees, and in a cross section orthogonal to the axial direction of the impeller, an angle formed between the flow path wall surface of the compressor inlet flow path and the flow path wall surface of the fluid introduction flow path on an upstream side of the axis of the fluid introduction flow path in a rotation direction of the impeller is less than 90 degrees; and
Condition (B): in a cross section along the axial direction of the impeller, the flow path wall surface of the compressor inlet flow path includes a first convex portion at a position on an upstream side in the axial direction with respect to an outlet of the fluid introduction flow path, and in a cross section orthogonal to the axial direction of the impeller, the flow path wall surface of the compressor inlet flow path includes a second convex portion at a position on an upstream side in the rotation direction of the impeller with respect to the outlet of the fluid introduction flow path.

13. The centrifugal compressor according to claim 12, wherein
Condition (B) above is satisfied, the first convex portion includes a convex curve in a cross section along the axial direction, and the second convex portion includes a convex curve in a cross section orthogonal to the axial direction.

14. The centrifugal compressor according to claim 12, wherein
Condition (B) above is satisfied, a distance between the first convex portion and the outlet of the fluid introduction flow path is smaller than a flow path width of the fluid introduction flow path in the axial direction at a position of the outlet of the fluid introduction flow path, and
when a direction orthogonal to each of the axial direction and the axis of the fluid introduction flow path is defined as a first direction, a distance between the second convex portion and the outlet of the fluid introduction flow path is smaller than a flow path width of the fluid introduction flow path in the first direction at the position of the outlet of the fluid introduction flow path.

15. The centrifugal compressor according to claim 1, further comprising:
a valve provided in an intermediate portion of the fluid introduction flow path, wherein
a valve seat surface on which the valve abuts is formed on the flow path wall surface of the fluid introduction flow path, and when a flow path area of an outlet of the fluid introduction flow path is denoted as Sp, and a flow path area of the fluid introduction flow path at a position of the valve seat surface is denoted as Sq, Sp≥Sq is satisfied.

16. The centrifugal compressor according to claim 1, wherein
when an area of an outlet of the fluid introduction flow path is denoted as Sp, and a flow path area of the compressor inlet flow path at a position of the outlet is denoted as Sv, Sp<0.35×Sv is satisfied.

17. A turbocharger comprising:
the centrifugal compressor according to claim 1; and
a turbine connected to the centrifugal compressor.
